(19) United States
(12) Patent Application Publication
(10) Pub. No.: US 2021/0174461 A1
(43) Pub. Date: Jun. 10, 2021

(54) RESTAURANT SERVICE AND MANAGEMENT SYSTEM

(71) Applicant: ORDAMO LIMITED, London (GB)

(72) Inventors: Daniel POTTER, London (GB); Noel HUNWICK, London (GB); Nicholas WENTWORTH-SHAW, London (GB)

(21) Appl. No.: 17/178,484

(22) Filed: Feb. 18, 2021

Related U.S. Application Data
(63) Continuation of application No. 14/621,578, filed on Feb. 13, 2015, now abandoned.
Application No. 14/621,578 is a continuation of application No. 13/639,982, filed on Jan. 4, 2013, now abandoned.

(30) Foreign Application Priority Data
Apr. 8, 2010 (GB) 1005873.3
Aug. 19, 2010 (GB) PCT/GB2010/051377
Nov. 29, 2010 (GB) PCT/GB2010/051982

(51) Int. Cl. G06Q 50/12; G06Q 30/00; G06Q 20/20

(52) U.S. Cl. CPC G06Q 50/12; G06Q 20/202; G06Q 30/00

(57) ABSTRACT

The field of the invention relates to management systems including a hub, a set of clients, and a point of sale system, the management system operable to be controlled by management tool software. There is provided a management system, comprising a hub, a set of clients, and a point of sale system, the management system operable to be controlled by management tool software wherein the management tool software provides a user interface. The management system may be used as a table management system in restaurants.

### CROSS REFERENCE TO RELATED APPLICATIONS

This application is a continuation of U.S. application Ser. No. 14/621,578, filed on Feb. 13, 2015, which is a continuation of U.S. application Ser. No. 13/639,982, filed Jan. 4, 2013, which claims the priority of PCT/GB2011/050703, filed on Apr. 8, 2011, which claims priority to Great Britain Application No. 1005873.3, filed on Apr. 8, 2010; International Application No. PCT/GB2010/051377, filed Aug. 19, 2010; and International Application No. PCT/GB2010/051982, filed Nov. 29, 2010, the entire contents of each of which are hereby incorporated in total by reference.

### BACKGROUND OF THE INVENTION

### Field of the Invention

The field of the invention relates to management systems including a hub, a set of clients, and a point of sale system, the management system operable to be controlled by management tool software.

### Technical Background

Many processes involving sales lack centralized control and provide only a limited set of services. One example is a normal restaurant, in which food and drink are ordered from a waiter who then takes the order to the kitchen and delivers the food and drink as they become available, with no central control over the restaurant processes; the only service provided is food and drink services. If the customer wants to play a computer game, he has to bring his own hardware and software. If he wants to edit an Excel spreadsheet, he has to bring his own hardware running Excel software. If wants to view a movie, he has to bring his own hardware and software, with content either present on the hardware, or accessible using the software running on the hardware.

### Discussion of Related Art

In WO2008071979A1, which is incorporated by reference, there is described an interactive food and/or drink ordering system, in which a computer controlled projector is mounted above a surface such that a menu of food and/or drink selection options is projected onto some or all of the surface. The selection options are selectable by a user operating an interface device connected to the computer, such as a wireless track pad.

In WO2011021045A1, which is incorporated by reference, there is described a combined table and computer-controlled projector unit, comprising: (a) at least one table; (b) a stand supporting the table; (c) a projector controlled by a computer; and (d) an imaging system mounted on the stand, the imaging system causing an image to be projected onto the table. Because the unit combines both a table and the computer controlled projector unit, it can be readily installed and does not require any ceiling cabling.

In PCT application number PCT/GB2010/051982, which is incorporated by reference, there is described an interactive food and/or drink ordering system comprising a computer controlled projector apparatus and a horizontal surface, wherein images from the computer controlled projector apparatus are projected onto some or all of the surface, the images including a menu of food and/or drink selection options, the selection options being selectable by a first user operating an interface device operable to provide input to the computer and also by a second user operating an interface device operable to provide input to the computer, wherein the menu of food and/or drink selection options is projected into a zone on the surface that is shared by the first and second users.

In prior art FIG. 7, two projected menu zones are shown as the circles with dashed lines; each person has their own menu zone, with text and images generated by a single overhead projector facing them appropriately. Each person has their own Bluetooth wireless trackpad, each shown as the small circle with a solid line. In FIG. 7, the two projected menu zones are on a table surface. The table has next to it a first seat and a second seat, for use by respective first and second persons.

The approach in prior art FIG. 7 makes menu selection and menu interaction a self-centered process—i.e. it is not an experience that is shared by the various diners sitting at the table. Also, the location of the projected menu zone may be fixed and defined, and hence relatively inflexible.

### SUMMARY OF THE INVENTION

There is provided a management system, comprising a hub, a set of clients, and a point of sale system, the management system operable to be controlled by management tool software wherein the management tool software provides a user interface.

The management system may be one wherein the management tool software is running on a computer terminal connected to the hub.

The management system may be one wherein the management tool software is running on the hub.

The management system may be one wherein the hub comprises an ordering process.

The management system may be one wherein the ordering process is associated with a client.

The management system may be one wherein the hub comprises a web service.

The management system may be one wherein the web service is associated with a client.

The management system may be one wherein the hub comprises an EPOS Abstraction.

The management system may be one wherein the EPOS Abstraction is associated with a client.

The management system may be one wherein the point of sale system is selectable from a set of point of sale systems using the management tool software.

The management system may be one wherein the hub is connected to an EPOS.

The management system may be one wherein the hub is operable to provide one or more of: an interactive food and/or drink ordering interface, a computer game, a computer software application, a movie, a playstation running game, or a Nintendo Wii playing game.

The management system may be one wherein the hub is operable to provide one or more of a plurality of client-facing software applications.

The management system may be one wherein the management tool software is operable to change a client facing interface in real time.

The management system may be one wherein the management tool software requires a username and password, so that only designated staff can operate the management tool software.

The management system may be one operable to receive input from a plurality of input technologies.

The management system may be one operable to receive input from a games remote control.

The management system may be one wherein the management system is a table management system including tables.

The table management system may be one wherein each table is operable to run a client from the set of clients.

The table management system may be one wherein the management tool software is operable to select a particular client from the set of clients to run on a particular table.

The table management system may be one wherein the hub is an E-Table hub.

The table management system may be one wherein the management tool software is operable to change a client facing interface at a table.

The table management system may be one wherein a receiver associated with a given table is operable to receive input from a plurality of input technologies.

The table management system may be one wherein a receiver associated with a given table is operable to receive input from a games remote control.

The table management system may be one wherein a given table provides an interactive food and/or drink ordering system comprising a computer controlled projector apparatus and a horizontal surface, wherein images from the computer controlled projector apparatus are projected onto some or all of the surface, the images including a menu of food and/or drink selection options, the selection options being selectable by a user operating an interface device operable to provide input to the computer.

Use of the management system may be in a stadium, a hotel room, a conference centre, an airport, a nightclub, a train, an aeroplane, or an e-learning centre.

The management system may be used as a table management system in restaurants.

### BRIEF DESCRIPTION OF THE DRAWINGS

FIG. 1 shows an example of a table management system, comprising a hub, a set of clients, and a selectable point of sale system, the table management system operable to be controlled by management tool software wherein the management tool software provides a user interface.

FIG. 2 shows an example of screen output provided by a table grouping and parameter selection system comprising tables and a table management system, the table management system comprising a hub and a point of sale system, the table management system operable to be controlled by management tool software wherein the management tool software provides a user interface, the management tool software operable via the user interface to select groups of tables, and to apply a set of selectable parameters to each group of tables. The screen output has been annotated.

FIG. 3 shows an example of a table management system, comprising a hub, a set of clients, and a point of sale system, the hub operable to be controlled by management tool software wherein the clients are operable to be changeable in real time and can be allocated by restaurant/hotel, stadium etc. manager, and the hub is operable to receive input from a plurality of input technologies.

FIG. 4 shows an example of a table management system, comprising a hub, a set of clients, and a point of sale system, the hub operable to be controlled by management tool software wherein the clients are operable to be changeable in real time and can be allocated by restaurant/hotel, stadium etc. manager; the hub is operable to receive input from a plurality of input technologies; the table management system is operable to receive input from a games remote control unit.

FIG. 5 shows schematically an example of a system comprising:

(i) a multi-establishment table management system comprising a super-hub operable to be controlled by super-hub management tool software, and

(ii) a plurality of table management systems, each table management system comprising a hub, a set of clients, and a point of sale system, each table management system operable to be controlled by respective management tool software,

wherein the super-hub is connected to the plurality of table management systems.

FIG. 6 shows a diagram of a restaurant table system which may be implemented in examples of the invention, and the connection of the restaurant table system via a server to other peripherals or networks.

FIG. 7 shows two projected menu zones on a table surface, according to the prior art.

FIG. 8 shows use of a single, shared projected menu zone on a table surface.

FIG. 9 shows how a table for ten people may be arranged so that there are three different shared menu zones.

FIG. 10A shows how for a table made up of four people in a single group, both palettes control a single order for the entire table.

FIG. 10B shows there are two separate groups of two people; two separate palettes are tracked by a web camera.

FIG. 11A shows there are two separate groups of two people; two separate palettes are tracked by a web camera.

FIG. 11B shows a small circular pointer 110, 111 with a short handle placed on each palette; the position of the pointer can be detected and tracked using the web-cam.

FIG. 12 which is a perspective view of a combined table and computer-controlled projector unit: reference may be had to concept G.

FIG. 13 is a schematic of the main elements of an exemplary interactive food and/or drink ordering system. This may be used together with the unit of FIG. 12. This may be used in the context of other examples of the invention.

### DETAILED DESCRIPTION

### Overview

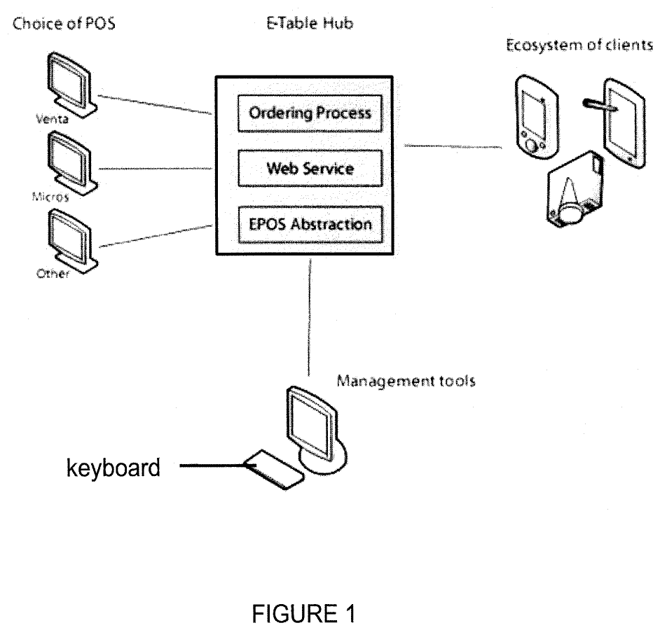

When we use the word “E-Table” in this document it may for example be referring to any Server-Client hardware and software combinations as shown in FIG. 1. In FIG. 1, there is shown an E-Table Hub including an Ordering Process, a Web Service, and an EPOS (electronic point of sale) Abstraction. The E-Table Hub is connectable to Management tools. The E-Table Hub is connectable to an Ecosystem of clients. The E-Table Hub has a choice of POS (point of sale) technologies such as Venta, Micros or others. Seating arrangements comprising tables, and/or places at a counter, are possible.

Some other locations where our technology may add extra value:

Executive boxes at football stadiums: So corporate clients may order food and drink direct from their box as well as watching replays of the goals. This may be applied more broadly to sports stadiums and instant replays. E.g. tennis; Olympics stadiums. A customer may use all of the usual E-Table features

Hotel bedrooms

A customer may use all of the usual E-Table features

A customer may order room service; pre order dinner; watch a movie etc.

A customer may see what facilities are available within the hotel

A Customer may changes their environment and mood lighting within the room as a whole (e.g. projections on the wall, regular lights with dimmers, fibre optics, lasers may all be controlled through the E-Table input.)

Hotel Conference Centres:

A customer may use all of the usual E-Table features

A customer may view a table displaying powerpoint presentations, ordering or choosing between their meal.

Airport Travel Locations

A customer may use all of the usual E-Table features.

Nightclubs

A customer may use all of the usual E-Table features

A customer may control the overall ambience (as per the hotel bedrooms).

Ordering on planes and trains

A customer may use all of the usual E-Table features

A customer can view movies in a plane using one of the E-Table clients

A customer can view their flight plans and times through the E-Table

A customer can view their connecting flight through the E-Table

A customer can see a cockpit-Cam through the E-Table system

A customer can play the regular E-table games through the E-Table system.

Travel (A customer may order their duty free shopping using an E-Table)

Airport Travel eateries (with duty free shopping)

E-Learning centres

A customer may use all of the usual E-Table features

A customer may interact with the E-Table database to learn about all of the individual food items

A customer may use the E-Table independently of all of its usual features and may have separate learning features taught straight through the hardware. These features may be interactive between people on either side of the table.

Document sharing

The E-Table may be used as a repository of data at events/meeting seminars/hotel places etc. as a focal point for where business people can share data, documents etc.

### Purchasing

Standalone games are built and provided, which may run on a portable device e.g. an iPhone/wireless device. These games may be purchased by wirelessly linking the customer's iPOD/blackberry/general PDA/general phone device. There may be a fee which goes to the restaurant or to the central Compurants hub through this.

3rd Parties may build and provide E-Table apps which work on the E-Table but are also designed to be downloadable.

Trailers for movies may be shown on the tables and DVDs/Blue Ray discs may be purchased and written to disc at the restaurant and the price added to customers restaurant bill as they walk home with a hard copy of the DVD.

An ingredients list of the food items available at the restaurant may be viewed by the customers. In a restaurant like Inamo, the ingredients lists are quite unusual and difficult for a member of the general public to get hold of. A customer may through this list select individual ingredients that they would like to purchase and take home from the restaurant and these may either be given to the customer to take home at the end of the night or they may be delivered by the restaurant at an agreed time. The purchase price of these items may be added to the customer's bill and this can provide an extra revenue source for the venue.

An Inamo/restaurant cookbook may be visible on the table and may be ordered either to take home or for home delivery at a later date.

### Social Events Using the System

Dating application

A customer may visit a social networking party—e.g. speed dating. This may be a pre-arranged party. This may link into a facebook application.

Customers may walk in off the street to visit a dating night that the restaurant has arranged for marketing.

Customer tracking may be used.

### Camera Tracking

A customer's order may be tracked from the point at which he sends it to the kitchen until the point at which it arrives at the table by route of a 2D barcode (potentially infra red so that the customer can't see it) being placed on the plates and that code being recognised by the camera in the E-Table. This may be used to give information to the customer (e.g. your dish took 23 minutes to arrive—that is too long so your meal will be free!) or it may also be used to gather metrics for the restaurant giving very clear data of exactly how long every dish in the restaurant takes from the point of being ordered to arriving on the customer's table. This is a valuable metric.

Dish tracking of this nature may also be used to see if a group of customers are sharing food or if they each are eating individually.

The camera technology may be used to check if a customer's drink needs refilling. The camera may recognize how full a customer's glass is and either prompt the customer to place a new order or prompt a waiter to come over and top up their glass.

New Technologies, Customer data Tracking & Loyalty

The individual guest data may be tracked through a variety of means and this may be used for a whole host of revenue generation options for a restaurant as well as increased customer satisfaction, increased efficiency and enhanced customer experience.

The tracking may be done through a variety of means.

RFID identification

Customer loyalty cards.

2D Barcodes printed out at reception/before hand from a website

Face recognition through a camera

Pre-Booking through a website

Some of the benefits of tracking customers in this way may include but are most certainly not limited to:

A customer sits at his table and a little piece of user interface pops up saying “Hello Mr Jones” . . .

A customer is presented with his favourite dishes

A customer is recommended a wine that he may like judging by previous orders

A customer is offered customer loyalty points which provide marketing deals such as: 2 for 1 dishes/drinks, 30% off your meal, bring a friend to eat for free etc. all through the E-Table system.

This customer data may link into their facebook/Amazon/google/twitter status.

Twitter updates may be provided directly through the E-Table system. E.g. “I am at Inamo and it's amazing—you guys have to see this place”. This may be opt in.

The customer data may be linked in to, for example, Google latitude and automatically post an update: I am at Inamo. While we have used Inamo for both these examples, it is clear that this may be used as great marketing for any restaurant.

The customer may link into their dining out website profiles e.g. toptable/square meal etc. through the E-Table system posting positive/negative reviews about the restaurant experience in real time. This may serve as a new feature on the sites. “I'm at Restaurant X now, and the food is fantastic tonight, service is as good as it's ever been!”. This may drive additional people to the websites and to the restaurants.

A customer can be upsold items of food based on their customer profile. E.g. Hi big spender! Last time you ordered the black cod, the rice and the miso soup. We've got a new dish which is just like the black cod and even better—for £5 we can make you a special black cod with our new tangy caviar sauce!

The E-Table retains the data of who the customer is and when they customise their table top, the ambiance selection they have for the longest time is recorded. The next time customer comes the number and the table comes up the same ambiance as previously.

When the E-Table starts New features promotion on the table top

A customer sees a ‘New’ graphic telling him that the menu item is new for any new product on the menu since her last visit.

A customer can record her dinner. This will keep a record so that next time they arrive, they can simply order the same meal again.

Customers can build their own Avatars so that each time they come to the restaurant they've got a little friendly face they remember. This may be remembered in a single restaurant or table to table across multiple restaurants.

The above bullet point can link in with the shared experiences/multiplayer games section whereby each user within a restaurant can add a piece of an avatar to create silly people and creatures. It can also link in with the loyalty scheme whereby each time they come to the restaurant they get to add an extra bit of their avatar/upgrade their avatar to make it/him/her increasingly life like/cool/funny.

2D Barcodes on the dishes/RFID on the plates may provide dishes that “talk to the customer” as they arrive. As the dish is recognized by the camera/RFID, an audio mechanism may literally say Hi I'm your rarely cooked steak for the day!

The cameras may be used to literally record the dinner with a large group for playback later. The diners may download their movie of their dinner from the restaurant website at a later date (for a fee) or they may have it printed out onto a DVD at the restaurant.

A customer may use the overhead camera to teleconference other tables, video phones outside of the restaurant.

An Inamo E-Table application may be downloaded from the E-Table to a customer's iPhone/wireless device which offers free drinks/special deals/priority reservation etc. in exchange for allowing status updates from the restaurant and receipt of promotional material. This may be combined with sponsorship from e.g. alcohol suppliers. Such an application may have within it the agreement to “auto-tweet” or some such. Customers may also book direct into the restaurant from such an app.

Customers may use the camera recognition/IR button recognition to move the projections on their E-Table around with them.

Customer Loyalty

A customer views a continuing theme occurring and developing over time—e.g. next chapter in a comic strip encourage them to return regularly. Don't miss next week's fantastic episode! Also may include tv style mini series created just for the restaurant! E.g. How will the ratman escape this sticky situation?

A customer leaves a tablecloth or game not finished—and comes back and continues from where left off the next time they enter the restaurant.

### Linking to Social Networking Sites

Facebook

An application may be built and provided on e.g. facebook or an apple iPhone/wireless device app which allows people to organise groups together and book a large restaurant table through the app. The food to be had at the meal may be pre-priced using the app and may link directly into the E-Table system so that customers can order their food in advance, enjoy the other features of the E-Table system and eat extremely quickly and efficiently.

Facebook events may be linked directly to meals at the restaurant. A group arriving may see “Welcome Alice's 30th Birthday party!” and may in principle say hello to all of the guests as they sit down at their table (linking in with some of the ideas from earlier).

Something may be provided on (for example) facebook which says “let's go to dinner at Inamo together” as e.g. a date, a friend, a chess match and the booking may be made straight through a reservation system recognising the customers as they arrive and having the purpose of their meal pre set. E.g. if it's a date, the tables are set to a romantic mood, if it's a chess match, a chess application may be preloaded on the E-Table, if it's a friend, it may take some of the pictures of the two of them on facebook, download them direct to the E-Table and have those showing (note this may obviously require some kind of legal agreement with facebook or some such).

A customer can view their friend's twitter feeds through the E-Table.

A customer can send a feed directly through to twitter from their E-Table

A customer can search twitter feeds directly through their E-Table.

Personalisation for Own Environment e.g. Customer Booth

A customer can use a juke Box application to select music from a list that the whole restaurant/location would listen to. There may be a price per song and it may form part of a song queue. This may link in to itunes or some other online purchasing store.

A customer can use a jukebox application in a private E-Table booth which allows a small group to listen to music within the E-booth

A customer can use the E-Table to set the colours of the walls & floors and change lighting levels as well as just their own tables.

An E-Table may use camera/sound recognition/food ordered/facebook data etc. to determine the mood of the customer and may automatically respond by changing the lighting level in the restaurant/private booth or this ma be used to alter projections on walls/floors/unused customer tables. This may be done in real time using a microphone and the visual images displayed may respond directly to the sounds created by the guests. Each frequency can be directly represented by a coulour/pattern/shape.

The above bullet point may be taken further to create social games in locations whereby individuals e.g. clapping their hands on E-Tables create responses from the restaurant as a whole where the section of the restaurant clapping loudest gets their tables coloured brightest and a power bar may fill up until the point where a goal is achieved and that part of the restaurant receives a free bottle of champagne! This type of idea can be used to market restaurants and event locations.

A customer may use their E-Table to directly change the animations on the walls in the restaurant/private booth

The ambiance of the restaurant/private booth may automatically respond to the number of people in the restaurant.

The ambiance of the restaurant/private booth may automatically respond to what customers in the restaurant are ordering.

The ambiance of the restaurant/private booth may automatically respond to the games being played

The ambiance of the restaurant/private booth may automatically respond to the time of the day

The E-table/private booth may enable theme animated tablecloths eg pond with fish or vine growing

The ideas in this section, may be monetized (among other ways) by charging a premium fee for small groups to hire out private booths which use the E-Table and whereby their private ambiance can be controlled. On a broader restaurant scale, it can be used to attract customers.

A customer may visit a restaurant which is itself wholly and completely customizable. The guest may not only set the sound and the ambiance but may fully move the robotic tables with raising and lowering floors. The guest may arrange the ambiance, layout and food all in advance of their arriving through an online application which may appear on a website or an iPhone/wireless device etc.

One of the E-Table clients may be a phone or an iPhone/wireless device running an iPhone/wireless device app. This may be done in real time or in advance. This may provide promotions for the menu

A customer uses all of the usual E-Table features

Ability to change table

Buy music being heard in the restaurant

One of the E-Table booths may be used as an “Action Zone” within a restaurant/hotel. Similar to the charades idea discussed later in this document, whereby the user of the booth puts themselves on camera (potentially with sound) and is viewable across multiple restaurants but much broader allowing for karaoke, acting scenarios etc. The user gets their moment of fame and may be put on the E-Table network, website, youtube etc.

### Text Message Services

A customer can connect to texting service to send messages

A customer may send a template text from a selection in a list (or a custom text using an on table keyboard) e.g. an ‘I am at the restaurant’ text. This may be linked directly into a telephone network/a texting website. The cost of the text may be added to the bill at the end of the meal. A premium may be added to this text and may provide an additional revenue stream for the restaurant. This additional revenue stream may also come back to the people running the E-Table system.

The restaurant may send texts direct through the e-table system and to loyal customers on their phones when there are new games or menu updates.

Customers may text in to a central server to win automatic promotional points that may be accumulated through their tables.

Customers may be texted (via multimedia) a 2D barcode which they may bring along to the restaurant and when they place their phone/PDA on the table with the barcode on screen, it may instantly recognize them from the text that was sent to them.

### Simple Games

The coin table football game (Where you have three coins and have to shoot them into a goal made up of the other person's hand) may be played using an infra red camera device, for example as proposed in PCT application number PCT/GB2010/051982.

The coin table rugby game may be played likewise (where you have to throw the coin over a set of rugby posts created by the other player's hand).

### Shared Experiences and Multiplayer Games

Customers can all play a group game through the E-Table system as opposed to just playing on their own table. More than one table to play

A customer competes in quizzes against other customers in the restaurant. Prizes may be handed out for most correct answers/quickest answer. This can be used to drive custom in a restaurant.

There may be drinking games which for everyone competing needs to (optionally) choose to pay for drinks. This leads directly to extra revenue but the drinks may be served in a separate section of the restaurant (e.g. the restaurant bar) hence driving further custom and extending stay times and increasing customer expenditure.

A customer receives prizes for winning a competition and the prize may be served in a different section of the restaurant (e.g. the bar) hence driving further custom and extending stay times and increasing customer expenditure.

“Subbuteo” or similar games may be played across multiple tables as a shared game.

A customer can play a type of Wac-a-Character game with their infra red pointing device and use it to compete against multiple gamers.

There are many communal games/activities that may work beautifully using the E-Table system, where the system is for example as described in PCT application number PCT/GB2010/051982. These include:

Consequences style game

Charades (A group may take an E-Table booth where a camera records them playing charades and they get their moment of fame visible by the other diners in the restaurant on their “Charades-Cam”. This may combine very well with the multi-restaurant possibilities which allow all people at E-Tables anywhere to see the charades players entertaining themselves.

Building things using multiple people e.g. avatars, cars, buildings, etc. each person playing across multiple platforms provides a part and this tallys up to create a communal creation.

The E-Table technology may be used by a group of e.g. physicists to share their information and papers in a nice environment using the format laid out in the general use section.

The E-Table/any restaurant website can be given a widget which prompts customers to order their first cocktail in advance of ordering. This is a form of upselling which will increase average spend an increase efficiency from the customer's point of view. Such a website may also prompt the user to invite a friend to the restaurant along with them.

A customer can pre-arrange the exact times that every dish arrives for a group of people dining. They can do this through a website/iPhone/wireless device and it may link directly in to the E-Table system—this may further link into the dish arrival (e.g. by 2D barcode recognition) allowing the restaurant to record variation between the planned arrival time and the time the dish actually arrives.

### Multi Restaurant Experiences and Multi-Restaurant Games

All of the above concepts may be extended to include players not just within one restaurant but within multiple restaurants and even further:

Versions of E-Table games can be released:

On hotel/restaurant websites

On social networking sites (e.g. facebook apps)

On wireless device/iPhone/wireless device and other phones (e.g. iPhone/wireless device apps)

On dining out sites

There may be a central server which houses the high scores and everyone can compete in a type of E-Table Olympics! Customers can be charged to compete in the games high score charts at e.g. 25 p per play.

This can be thought of in terms of old school arcade games and applying their billing process to E-Table/iPhone/wireless device/Facebook apps with prizes which may include Money prizes; Free meals at restaurants; Free rooms at hotels; Free flights. The potential for cross marketing across multiple different eTable and/or App users is absolutely immense.

High scores competed against restaurant to restaurant

Virtual Robots for restaurant/hotel created restaurant for each instance of an E-Table install. Those robots can compete in a kind of robot games based upon multiple possible criteria and the customers in the individual locations/or the locations themselves can receive rewards based upon the performances of those robots. Possible criterion include:

Number of customers in the restaurant

How many games are being played in the restaurant

Highest average spend in the restaurant

High scores in the games in the restaurant

Most button presses in the restaurant

Etc.

Restaurant customers may pay to compete or may be incentivized to spend more to help their restaurants' robots win the battles and then all guests on a given night for example may receive a free bottle of champagne. There may be big prizes handed out centrally from the E-Table runners for the best robots. Clearly there are many ways to look to monetize such an idea.

There may be a physical robot that walks around linked in to the E-Table system. The robot may either be controlled by an individual customer at an individual E-Table for a fee or it may be controlled in bit parts by multiple E-Table users. There may be multiple physical robots at multiple restaurants controlled by customers at each of those restaurants. These robots may try to bring food to the customer—which if the customer manages to successfully bring the food to the table they don't have to pay but if they fail, then the robot simply returns the food to the place it was originally sat at. The basic idea is that the customers pay for robot time and have a shared entertainment experience.

Robots as described in a separate section can be virtual or they can be physical little dudes. They can perform silly tasks for customers or they can compete against each other from one restaurant to the next. They can exist in virtual space as avatars. All can be controlled via the customers' E-Tables. Robots may become more capable and/or more intelligent the more they get used by a customer in a given restaurant.

The performance of each robot may depend upon how many people in the restaurant have used the robot, the average spend of the restaurant etc. This paves the way for “Restaurant Wars”!

### Miscellaneous

A customer can buy cinema tickets directly through their E-Table system.

Customers may order drinks in a restaurant section of an establishment at end of meal with a view to drinking downstairs

Customers may be allocated points for drinks which build up as more food is ordered and drinks given in the bar.

Guests may visit a virtual restaurant online and may navigate their avatars around the virtual restaurant.

A customer can arrive in the restaurant and download a web based application to their portable device and use it to order their food while waiting in the bar for a seat at the restaurant.

A customer experiences direct engagement through the E-Table system using the customer identification mechanisms. “Happy birthday mr Jones!”. This data may be populated from a directly from facebook in advance of sitting down.

A customer can use the infra red camera interaction to spawn animations such as a lightsabre.

A customer may view the E-Table through 3D goggles and a 3D image may be presented on the table. The customer may use the infra red camera pointing device to interact with a realtime moving 3D characters, landscapes and systems seeing a 3D world in front of them.

A customer may use such a 3D environment to get a better idea of the quantity of food they may be ordering.

There may be a virtual garden on the E-Table which restaurant guests use. The virtual garden may be commercially linked to a zero-carbon group who may actually plant real plants in the real world based on the virtual garden that gets created by E-Table users. The E-Table users may pay for their virtual plants to get planted and thus offset the carbon emissions of their meal. The virtual garden may, over time be mapped by a real garden in conjunction with such a zero-carbon group.

A customer can view the sports results directly through their E-Table system.

During football matches can use an RSS feed or link to BBC or other website

A customer can watch penalty shoot outs in real time through their E-Table

The football world cup or other competitions may be promoted through having the flags of the competing nations as the tablecloths and customers may select their nation's flag as their table cloth.

### E-Table System Go Vs E-Table General Use

The current E-Table is typically set up to run in conjunction with an EPOS terminal and in the case of the E-Table Full Install/The E-Table Portable runs two interfaces through one computer. Each of these is linked back through to a central server.

It is possible to, from the central server, turn off the interactive ordering and put a separate feed/stream through the tables. One may edit our CMS (Content Management System) to allow the individual tables to run separate software using the hardware that is already there. For example, one may link a playstation into the server and may thus play a playstation game through the E-Table Portable hardware (viewable either on a single table, or on multiple tables.

One can stream video on some tables in the restaurant and not others converting one room into a mini cinema.

Taking this a step further, it is possible to link multiple Playstations/Nintendo Wiis/X-Boxes etc. into the server and select which tables in a restaurant can run the games and which would simply be ordinary ordering. Instantly this can convert a restaurant into a games arcade!

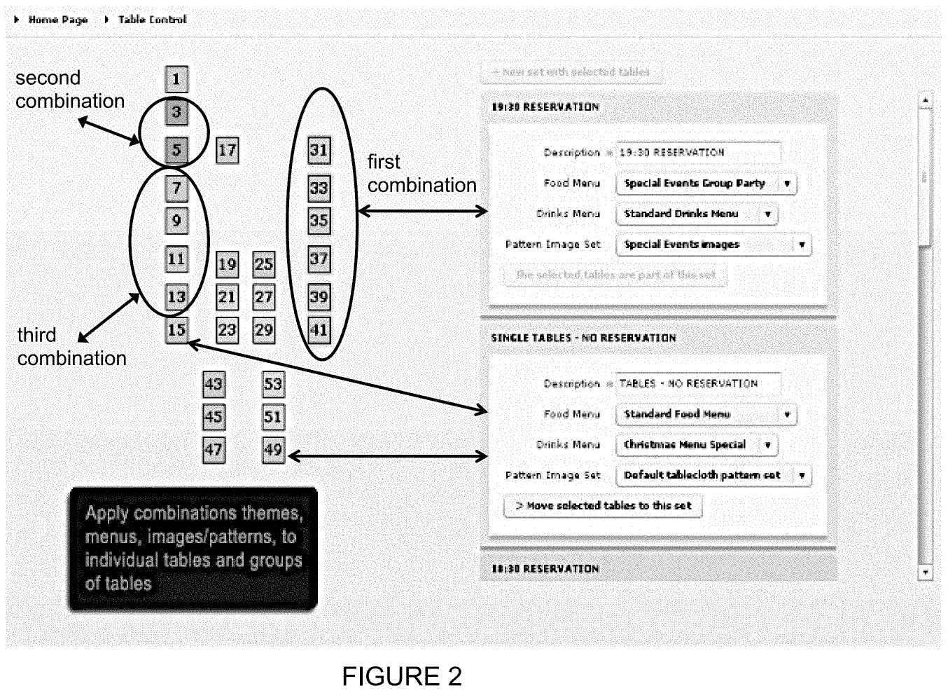

For an example, see FIG. 2. In FIG. 2, in the right hand side of the Figure there is shown screen output from a monitor of the control system, this output relating to the configuration of various tables in the premises. In FIG. 2, in the left hand side of the Figure there is shown annotated screen output from a monitor of the control system, this output relating to the configuration into tables or groups of tables of various tables in the premises. In the left hand side of FIG. 2, there are shown a first combination of tables, a second combination of tables, and a third combination of tables, each combination of tables corresponding to a group of tables. Tables within a group of tables do not have to be adjacent each other, though usually they will be selected so as to be adjacent each other. Seating arrangements comprising tables, and/or places at a counter, are possible.

This has further features of allowing a set of regular PCs to do this immediately providing a mechanism by which powerpoint, excel, staroffice, facebook, twitter may be fed to multiple E-Tables in the middle of a dining experience through the request of a customer and the management of a restaurant/hotel manager. You may have a software and hardware link which runs through a content management system instantly allowing a restaurant manager to allocate individual tables to do virtually anything that the client PC is capable of running through our hardware without running directly through the EPOS system while maintaining the realtime food data.

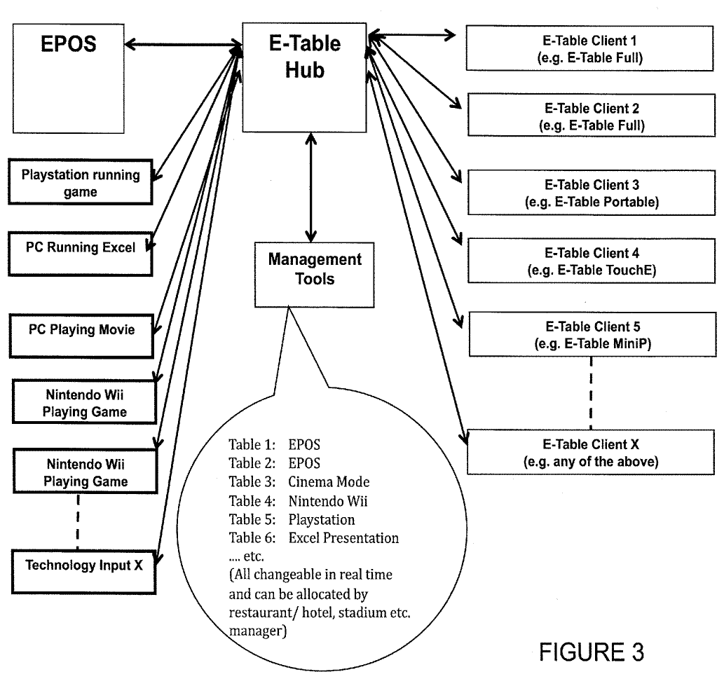

This can be thought of as a switch between normal E-Table operation and using the hardware in its more regular use and managing this process through our content management system. For example, see FIG. 3.

In FIG. 3 there is shown an E-Table Hub with various connections. The E-Table Hub is connected to an EPOS. The E-Table Hub is further connectable to various pieces of hardware each operable to run software. For example, the E-Table Hub is connectable to a playstation running game, a PC running Excel, a PC playing a movie, a Nintendo Wii playing game, a further Nintendo Wii playing game, and so on, which may be generalized as Technology Input X. The E-Table Hub is connectable to or controllable by Management Tools, which may provide an EPOS in relation to Table 1, an EPOS in relation to Table 2, a Cinema Mode in relation to Table 3, a Nintendo Wii in relation to Table 4, a Playstation in relation to Table 5, and an Excel presentation in relation to Table 6. Management Tools may enable the operation mode of each table to be changeable in real time, and to be allocatable by the manager of the premises. The E-Table Hub is further operable to run plural E-Table Clients, which may comprise various E-Table Client types, for example E-Table Full, E-Table Portable, E-Table TouchE, E-Table MiniP etc.

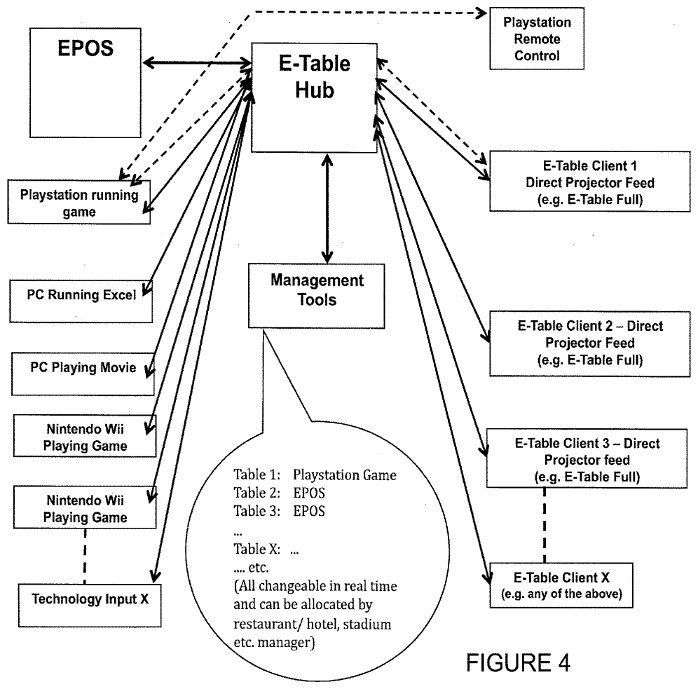

In the case of the E-Table portable and full E-Table install, this can run either directly through the client PC using one of the custom trackpads (or whatever input device is being used at that stage) or it may run just through the network of projectors and a completely separate piece of hardware may be used to interact with the hub. See FIG. 4 for example. The dashed lines with arrowheads show the information flows from the person using a games remote control to run a game directly on a console which is then being displayed on the Client hardware using only the projector and not the client PC. A receiver associated with a given table may be operable to receive input from the games remote control.

Applying the E-Table Hub concept to Multiple Restaurants

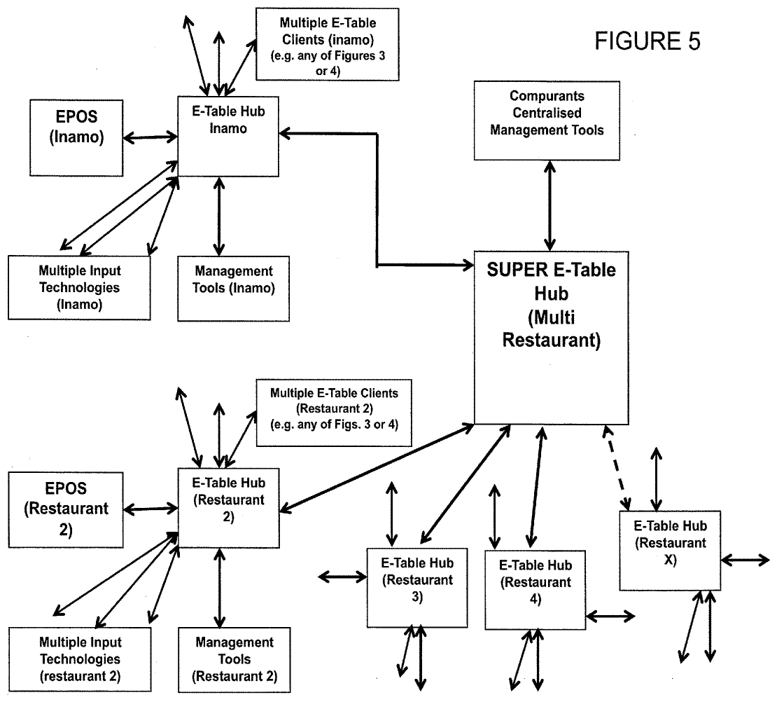

Much like the internet is built of constituent smaller networks and servers, one can conceptualise an E-Table-Work which consists of multiple E-Table restaurants grouped together. This may not transfer all of the private data, but would allow individual restaurants to game against each other, compare high scores etc. as laid out in the multi restaurant games section of this document. This may be taken further as a mechanism for individual restaurants to share important and valuable data if they were to opt in to that. For example, see FIG. 5. The skilled person will understand that FIG. 5 is highly schematic.

FIG. 5 shows the provision of a SUPER E-Table Hub (Multi-Restaurant), by way of example. The SUPER E-Table Hub is connectable to or controllable by centralized Management Tools. The SUPER E-Table Hub is connectable to an Inamo E-Table Hub, with is further connectable as shown. The SUPER E-Table Hub is connectable to an E-Table Hub of Restaurant 2, with is further connectable as shown. The SUPER E-Table Hub is connectable to an E-Table Hub of Restaurant 3, with is further connectable as indicated schematically. The SUPER E-Table Hub is connectable to an E-Table Hub of Restaurant 4, with is further connectable as indicated schematically. The SUPER E-Table Hub is connectable to a plurality of E-Table Hubs (as indicated schematically), with are further connectable, the plurality of E-Table Hubs including an E-Table Hub of Restaurant X, with is further connectable as indicated schematically.

It should be noted that a super E-Table hub may exist within an individual restaurant chain (e.g. multiple restaurants run from a single super E-Table hub to centralize all of their data as well as to work with the games, but an idea being put forth above is the idea of a SUPER SUPER E-Table hub whereby multiple chains and restaurants all share gaming, application (and potentially much more) data through a centrally controlled Compurants Server, or through some other centrally controlled server.

### OTHERS

### Ideas/Applications

### 1. Games (Including Ping, Pop'em)

2. Build your own pizza tool.
3. The following applications may be available:
a) A what's on at the cinema tool
b) A build your own cocktail tool
c) A virtual tour of the restaurant
d) A find your waiter tool
4. The following applications may be available:
a) The retail art tool
b) The trading price tool
c) A table drawing tool
5. APIs may allow external software developers to develop front end applications for our system.
6. A POSless E-Table system may be developed (for display purposes & for use in conjunction with any POS)—meaning one that can have input and output which is not through external POS (including table grouping), and including a fuller database, including output to printers.

### OTHER POSSIBLE PROJECTS

### Project 1: Guest Action Recognition

### User Scenario:

An overview of the target user scenario:
1. A group of diners arrive at the restaurant.
2. They are given an object(s) that is linked to their group within the restaurants computer system. This object(s) will be recognised anywhere within the restaurant as an identifier of that group and their orders.
3. The group sits at a table and places the object(s) on a table to reveal a menu(s).
4. The menu can either be shared by members of the group or menus can be shown for each individual user. The position of the menu can be defined by the location of the objects that trigger the menu.
5. Users then browse the menu(s) using either features within the menu-triggering object(s) or separate objects used specifically for pointing and selecting.
6. There are many exciting experiences that can be created using projectors and tracking. However, the hardest and most important foundation to get in place is reliable and accurate pointing and selection to provide reliable menu browsing system. This also needs to be partnered with a reliable method of identifying a group and relating that to orders made by that group.

Once that is in place one can introduce further, less critical, areas of interaction that can be used more for entertainment and game play. The sensors and activators for this may be separated from those used for core pointing and clicking to ensure pointing and clicking remains reliable.

### Features and Problems:

These are the key features and functions.
1. Uniquely identify the location and orientation (translation) of multiple objects on a surface.
a. Issues:
i. Very varied lighting conditions.
ii. Many other objects of varied heights on the projection/tracking surface (shadows, line of sight etc.)
iii. Ensuring human gestures and moving physical objects that should be ignored by the system do not confuse the tracking of objects and/or human gestures that should be tracked by the system.
iv. To only detect specified objects with a certain identification code and/or intentional human input (e.g. detect the difference between someone pointing at something and someone meaning to select something).
2. Point at items in a projected menu system, i.e. mouse pointer-like functionality. Translation of the menu itself is in relation to certain specified objects on a surface. Pointing should have as close to a mouse-pointer or computer track-pad level of accuracy.
a. Issues:
i. Lighting conditions as above.
ii. Other objects, both static and moving, as above.
3. Making a selection (e.g. clicking a mouse, tapping a touch-pad) in the projected menu system.
a. Issues:
i. Ensuring only intentional ‘clicks’ or ‘selections’ are registered.
ii. Ensuring a high level of confidence in the user that the system is doing what they ask.
4. Ensuring correct calibration between an objects location on a table and the resulting projected GUI (graphical user interface).
5. Keeping the cost of components down, especially at the user level.
6. The items that need to be tracked on the surface may be quite small in relation to the overall size of the projection surface. There may also be a number (e.g 20) of items that need to be tracked for various purposes on that projection surface.
7. Power requirements for table level items need to be considered in relation to battery requirements, sizes, and charging regimes. The less power and longer re-charging frequencies may be preferred.

### Possible Existing Technologies

These are technology items that may be combined in some way to achieve the above.

1. TECH: Infra-red capable camera (and related software/computer) to track items and send appropriate signals to the GUI.
NOTES: Choice of infra-red to:
a. Ensure any required markers/identifiers can be invisible from the user.
b. Ensure a consistent level of visibility in the widely varied lighting conditions caused by the GUI being projected onto the surface the camera would be looking at for identifiable objects.
2. TECH: HALIOS 3d pointer (see HALIOS 3d pointer notes below)
POSSIBLE USES: pointing at items, making a selection.
3. TECH: ANOTO digital pen (see ANOTO digital pen notes below)

POSSIBLE USES: pointing at items, making a selection, (possibly) positioning menus.

NOTES: The component that makes the pen work can be packaged differently. The projection surface may require the ANOTO pattern. The projected image may need to be positioned accurately in relation to the ANOTO pattern to ensure correct location of pen. The pen's components may communicate via Bluetooth to receiving computers).

4. TECH: Atracsys (see Atracsys notes below)
POSSIBLE USES: pointing at items, uniquely identify the location and orientation
5. TECH: Configurations of IR LED's in objects.

POSSIBLE USES: pointing at items, uniquely identify the location and orientation, making a selection.

a. Create a unique identification code (by flashing a series of LED to create a unique code).
b. Provide a high level of visibility to a tracking camera (by adding the correct IR filter to the camera to filter out everything but that IR from the LED's).
c. Work out translation via 3 LED's.
d. By employing a mode switch the transform of the object the LED's are embedded into can be used to position a projected menu on a surface, and then, once the mode is changed, to use changes to the position of the object to create mouse-like pointer.
e. An LED can be tracked as ‘click’ or ‘selection’ LED. When it flashes on the system registers a selection.
6. TECH: Infra-red inks (here)

NOTES: Useful to allow printing of unique patterns (such as QR code) in IR (infra red)/UV (ultra violet) (the UV element can be useful for quickly shining a black-light at so staff can see important info) in combination with visible inks, thus allowing the camera to see one thing (a unique code) and users to see another thing.

7. TECH: Printed bar code patterns

POSSIBLE USES: pointing at items, uniquely identify the location and orientation, making a selection (by temporarily removing from view).

NOTES: either using a code similar to QR code or bespoke code patterns. These can be printed in normal ink or using IR ink (this would help increase visibility to a tracking camera and hide the code from users)
8. TECH: Standard laptop-like track pad embedded into an object to.

POSSIBLE USES: pointing at items, making a selection.

NOTES: This may be used in combination with a Bluetooth controller.

### Possible Configurations of Technologies

These are some of the configurations of the technologies above.

1. Use an object with a single IR LED (light emitting diode) as a pointer/selector. The object can be a simple pen-like instrument with a downwards aiming IR LED as its tip and a pressure switch to activate the LED and shine IR light onto the surface directly in front of the pen. An IR camera can then recognise and track this IR light. A ‘click’ on the table surface can be responded to as a mouse click. Each pen can have a unique code embedded into it. A ‘click’ of the pen on the projection surface will cause the LED to flash a sequence of pulses that represent the pen's unique ID code. Holding the pen down for longer can trigger a variety of different light flashes that can be responded to in different ways such as tracking gestures, drawing and so on. This will provide a touch-surface like experience with the user pointing a physical object (the pen) at items on a projected interface. It will also ensure that a click only occurs when using a specific pen, thus preventing unintentional selections. This can be used in two main scenarios:
a. Pen only.

Makes use of the unique identifier of a pen to register it to a group. The pen can be used to activate menu anywhere in the restaurant and then to browse the menu and re-position it using a ‘drag menu’. Any orders made on that menu are logged to the group the pen is registered to.

i. When a person or group arrives at a restaurant a member of staff activates each pen's ID to register a pen to an individual or group within the system. Then gives the pen to each person in the group.
ii. Each person then sits at any table and presses the pen on the surface in front of them to activate the pen's ID. The system then recognises the pen and activates a menu. The default location and rotation of the menu can be determined by the position where the pen was first recognised.
iii. From then on any ‘click’ pulses of the pen's LED can be used to register a click wherever the pen is clicked and allow browsing of a menu.
b. Pen and Menu Identifier.

Using a menu identifier to activate and position a menu anywhere in a restaurant. The menu identifier is registered to a group. Pens are then used to browse the menu.

i. When a person or group arrives at a restaurant a member of staff provides them with an object with a large IR printed unique identifier on its top surface and registers it to a group on the system. The object then becomes the group identifier. Each person is then provided with a pointing pen.
ii. The group then sits at any table and places the group identifier on the table. This triggers a projected menu to appear and positions it in relation to the group identifier.
iii. Each person can then use any pen to navigate the menu.
2. Use either IR printed markers to uniquely identify an object that can trigger and translate a menu and objects containing a single IR LED that illuminates when pressed onto a surface. These may be simple pencil like objects with a pressure switch as a tip with the LED near the tip. When pressed on an item in the projected menu the LED illuminates briefly, and infra-red capable camera recognises the location of the LED's flash and lets the system know a ‘click’ occurred at that point. An un-limited number of pointers can then be used and the system would need to know how to deal with an unlimited number of ‘clicks’ possibly occurring at the same time.
3. A single object containing arrays of IR LED's that perform separate functions:
a. 3 LED's provide triangulation of position and rotation for moving either the menu or the pointer based on a mode switch.
b. 1 LED acts as a mode switch. If it is on then the object acts as a mouse with translation of the object moving the mouse. If it is off then translation of the object moves the menu.
c. 1 LED acts as a ‘click’ or ‘select’ identifier. When it flashes the system recognises a mouse click.
d. 5 (or more/less) LED's flash in such a way as to provide a unique identification.
4. Use either IR printed markers or flashing IR LED's to uniquely identify an object that can trigger and translate a menu. The projection surface has the current Bluetooth/track pad solution fixed into it providing pointing and clicking. Menus can be moved anywhere but the pointers are fixed.
5. Use either IR printed markers or flashing IR LED's to uniquely identify an object that can trigger and translate a menu. This defines a local zone in relation to the projected menu in which human gestures can be tracked as a pointer and possibly a selection.

### Project 2: Table Drawing Tool

The table drawing tool is an application that allows customers at tables to create their own tablecloth images. A tablecloth image may be a 1050×1050 pixel image that is layered behind the user interface on tables.

### Goals

The aim is to find a number of methods of creating attractive graphics that can be used as tablecloths, and build a prototype that ties these methods together in an intuitive tool that anyone can use without instruction.

### Criteria

Firstly, the criteria of the tool can be:

1. The tool should be fun. Using it should feel like a mixture of play and experimentation.
2. The tool should support the user who wants to make a good tablecloth in 30 seconds, as well as the user who wants to spend a few minutes on a more individual tablecloth.
3. The tool should balance two potentially competing forces: a) in order to make the tool quick to use, the user should provide simple gestures that the tool elaborates into more complex graphic elements, and b) in order to make the tool satisfying, the user should feel that the resulting tablecloth is their creation: that they have told the tool what to do, not that the tool has done the job for them.
4. Within reason, all output should look good. There should be no options that allow the creation of garish or unpleasant tablecloths, and use of the tool should not require artistic talent (though talent might help get the best out of the tool).

### Constraints

In addition there are a number of limitations imposed by the nature of our product that may be taken into account:

1. Although the area to display the tablecloth is large (eg. 1050×1050 pixels), the interactive area for all UI controls and drawing is very small: eg. 246×264 pixels, landscape orientation. This is the most important limitation of the system—it is very hard to fit much text or buttons in this space. It will be necessary to provide a small canvas on which to draw, and then allow the rendering of a high quality version.
2. Track pads. Drawing a specific shape with a trackpad is not easy. Testing the tool on a laptop with a trackpad will help you decide what motions are natural.
3. No buttons. Clicking is done by tapping the trackpad, so it is not possible to click-and-drag. This makes drawing lines very hard, so that should be avoided unless they are fundamental to the drawing method you are experimenting with. If you do want to draw lines, you might consider one of: click to start drawing and click to stop; click to start drawing a line that continues for a certain length (measured in cm or seconds); or clicking numerous times to provide control points which the line then flows between.
4. No keyboard.
5. The final product of the tool must be a static image—we may not support animated tablecloths.

### Drawing Methods

1. Offer ways to splash or scatter shapes over an image. For example the user may click a point in one corner of the canvas and cause a few leaves to be scattered around that area.
2. Customise an entity to your personal taste by selecting from a set of components. See zwinky.com for a very advanced example of this principle, though much simpler implementations are possible.
3. Accept crude line drawings and embellish them in a graphically pleasing manner. Reference may be had to scribbler by zefrank for a simple implementation of this idea.
4. Check out spirographs—line drawing algorithms that have relatively few initial parameters, from which complex shapes are produced. That general principle no doubt has other implementations than just spirographs, which are in fact quite hard to control predictably. The data for such an algorithm may be entered on a projected keyboard, or in a customized user interface.
5. Offer starting points other than a blank canvas. For example you might have some elements pre-arranged on the canvas but movable, or simply start with a backgrounds image or pattern and layer the user's drawing(s) on top of this background.
6. Distort bitmaps in creative ways.

### Restaurant Table System Example

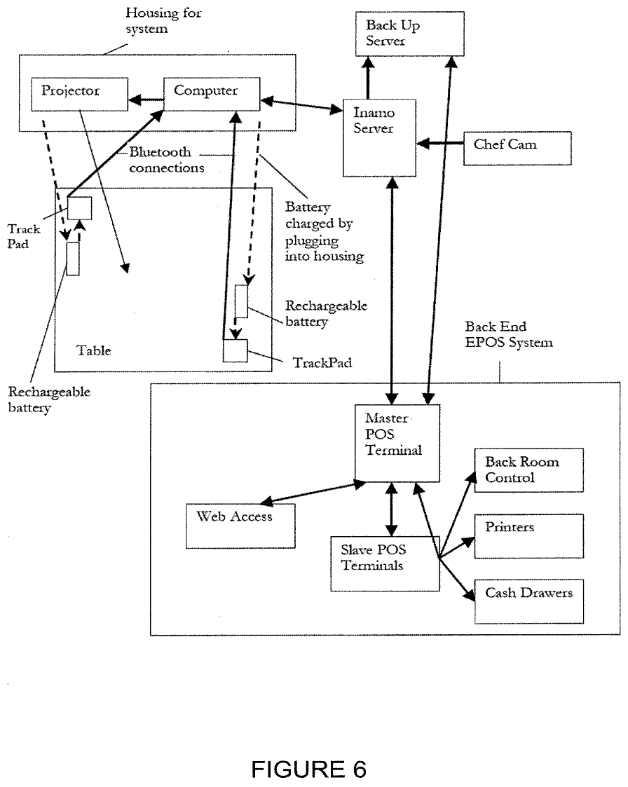

FIG. 6 shows a diagram of a restaurant table system which may be implemented in examples of the invention, and the connection of the restaurant table system via a server to other peripherals or networks.

In FIG. 6, a restaurant table for two diners is shown. A TrackPad is shown for each diner. Each TrackPad is connected wirelessly to an overhead computer. The TrackPads are each powered by a rechargeable battery. Each battery is recharged via a cable which may be pulled down from overhead and connected to the battery, preferably while customers are not present in the restaurant. This saves having to provide power to the tables. A projector is shown mounted above the table for illuminating the table surface. The projector above the table is connected to the computer above the table, both of which are in the same housing. The computer above the table is connected to a server which controls the computer for each of 45 tables for two diners. The server is the Inamo Server.

In FIG. 6, the Inamo Server is connected to a backup server, the chef camera, and to a Master Point of Sale (POS) Terminal. The Master POS Terminal is connected to web access, Slave POS Terminals, which are in turn connected to a Back Room Control system, printers, and to cash drawers. The Back End electronic POS (EPOS) system comprises the Master POS Terminal, web access, Slave POS Terminals, Back Room Control, printers, and cash drawers. In FIG. 6, the computer (eg. Client PC) is connected to the Inamo server (running the WES software) which interacts with a POS server—eg. one supplied by Sharp but it may be any (e.g. Aloha Systems, Micros, Fourth etc.). It is the POS Terminal which interacts with the back end equipment. All devices (including track pads, client PCs, projectors, Inamo server, master POS terminal, slave POS terminals, back room control, printers, chef camera etc are networked devices, each with an IP address.

### System with a Shared Menu Zone; System with a Plurality of Shared Menu Zones; Input Palette System; Input Palette; Input Pointer System, and Input Pointer

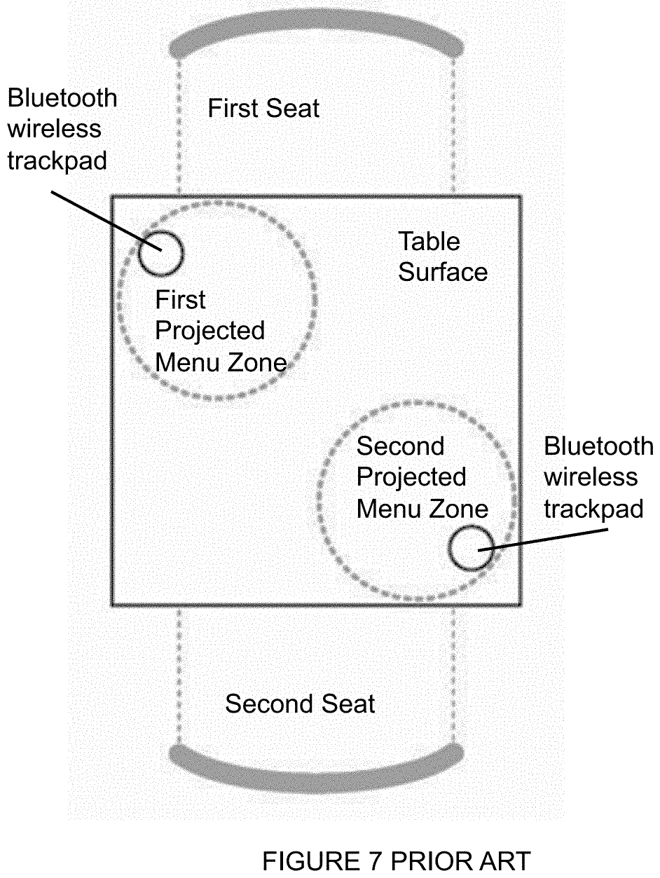

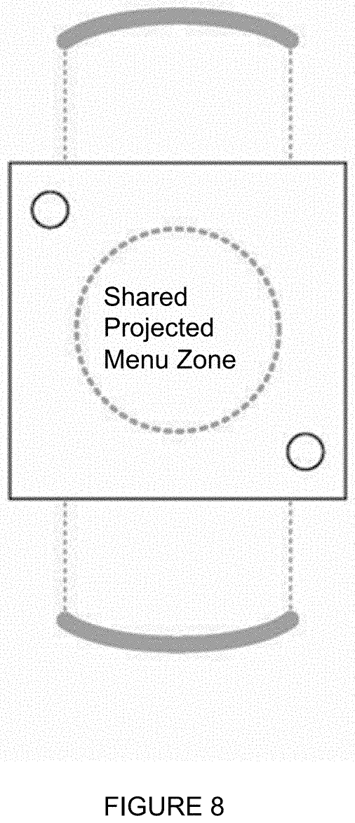

A different approach to that exemplified in FIG. 7 is to use a single, shared menu zone. The overhead projector can, for example, project a single image that is oriented so that both diners can read the menu items and can easily select their choices; the choices will be those of the table, rather than individual diners. Alternatively, the projector could project an image that is divided into a menu zone for one diner, and a different menu zone for the other (or each other) diner; the menu zones could have text and images appropriately oriented for each diner—e.g. one half could be oriented upside down relative to the other half. An example is shown in FIG. 8. This approach gives a shared experience.

A single, shared menu zone also allows for more flexible use of a given table area—for example, the two seat table described with reference to FIG. 8 can now readily be used as a four seat table.

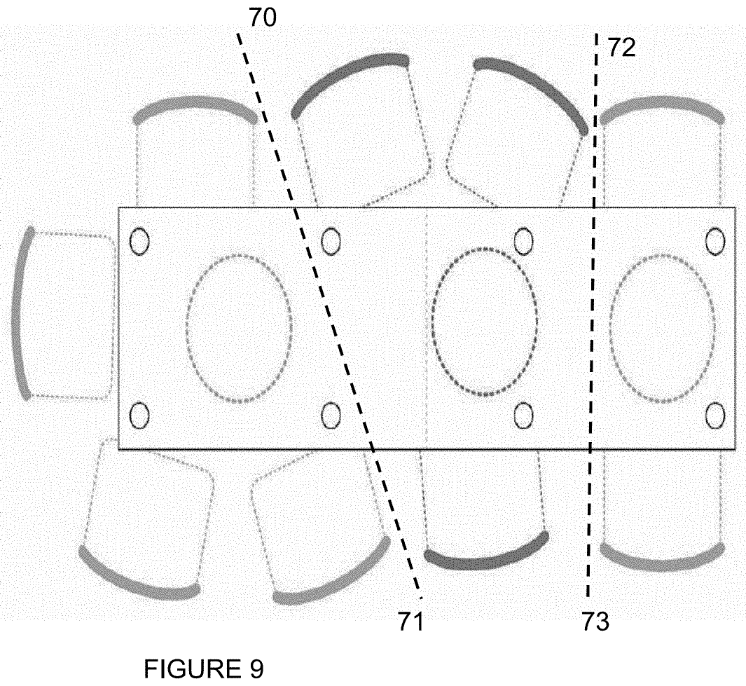

Flexible positioning of the various shared menu zones allows for odd (i.e. various) group sizes and seating arrangements. For example, a table for ten people is arranged so that there are three different shared menu zones—one for a group of four on the left hand side; another for a group of three in the middle and finally a group of two on the right hand side. An example is shown in FIG. 9. In FIG. 9, a dashed path from 70 to 71 distinguishes first and second parts of the table in the Figure; a dashed path from 72 to 73 distinguishes second and third parts of the table in the Figure.

Using a camera such as a web camera to detect and track a physical object provides a new approach to flexibility. For example, the shared menu zone is normally just projected by a projector onto the table top at a fixed location (albeit one that can be altered by the restaurant management to permit different seating arrangements to be used, different groups at a table to be provided with their own dedicated menu zone etc) as shown for example for the table in FIG. 8. But with another table, a flat, portable disc the approximate size of the shared menu zone is provided—the disc includes a small hole at one section, and resembles an oil painter's palette in shape. The palette is detected and tracked by a web camera; the position of the palette is then provided to control the position at which the menu zone is projected. To facilitate recognition of the palette, the palette can include images or other visual features with sharp, well delineated edges that can be readily recognized using image recognition systems; for example, the palette could include a 2D or 3D barcode. The image (e.g. barcode) does not have to be visible to a person, merely to the image recognition system. Hence, a barcode visible only in the IR (infra red) spectrum could be used. The palette should break azimuthal symmetry so that an image recognition system processing a camera image can determine the azimuthal orientation of the palette. If azimuthal symmetry is not broken in some way, such as with a featureless purely circular palette, one cannot determine the azimuthal orientation of the palette from an image of the palette.

Because the palette can be rapidly and reliably tracked, a diner can move the palette to any convenient position on the table and the shared menu zone will follow its movement, being continuously projected onto the palette and not elsewhere on the table. The projector may maintain a fixed background image on the table as the palette is moved.

The location of the handle can be tracked and identified as well—so that the shared menu zone orientation can vary as the palette is rotated. For example, with the palette in a particular position, the menu could be oriented by the overhead projector to present the menu correctly to the diner at the first seat; if a diner swivels the palette around, then the menu orientation can alter to face the other diner in the second seat.

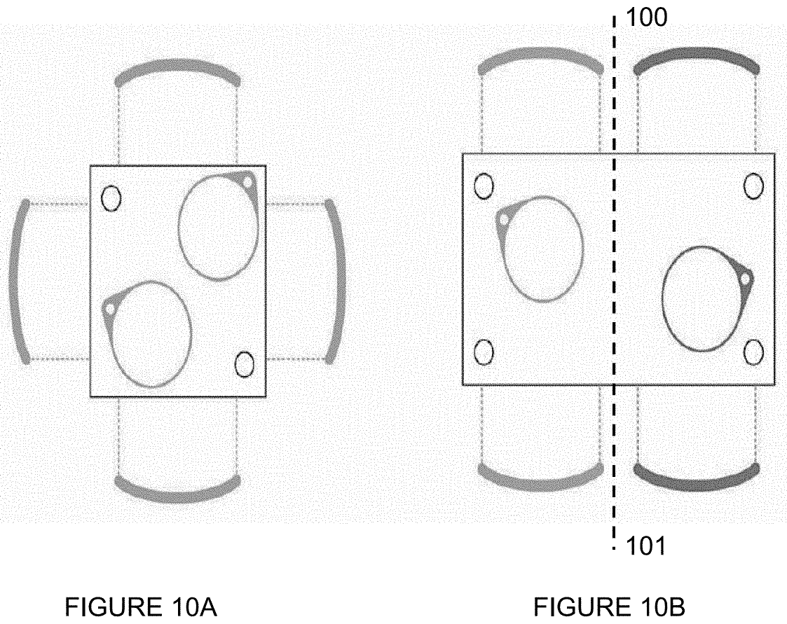

Using a web camera to detect and track a physical object allows for as many instances of a menu as there are physical objects to trigger one. For example, in the tables shown in FIG. 10A and FIG. 10B, we have two separate palettes on each table; for the table in FIG. 10A, made up of four people in a single group, both palettes control a single order for the entire table. But for the table in FIG. 10B, there are two separate groups of two people, indicated by the separating dashed line between 100 and 101. As shown for example in FIG. 10B, two separate palettes are tracked by a web camera (typically just one, but it would of course be possible to have more than one camera); separate menu zones are projected onto each palette.

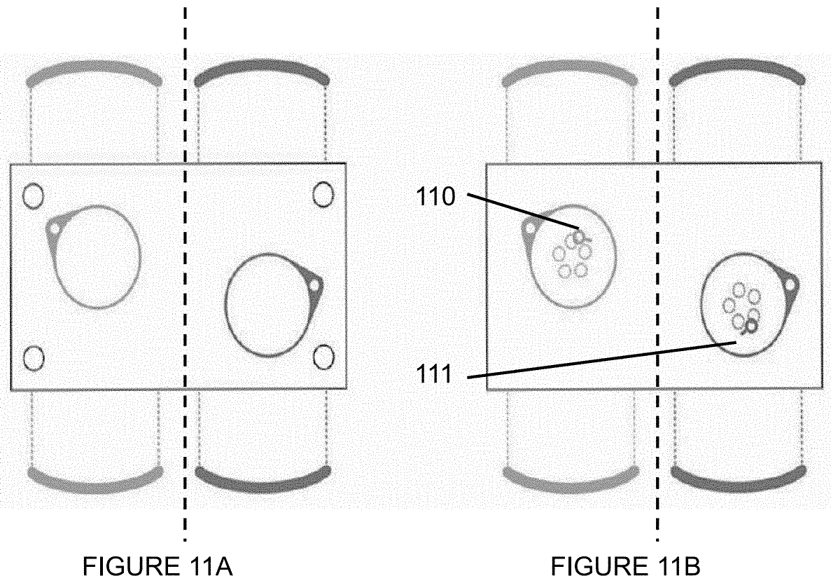

By expanding the use of web-cam detection and tracking, other physical objects can be used to interact with the menu. This enables the replacement of expensive touch-detecting equipment with basic objects (such as a piece of wood) with nothing more than a graphic that the camera can track. For example, in the table in FIG. 11B, a small circular pointer 110, 111 with a short handle is placed on each palette; the position of the pointer can be detected and tracked using the web-cam. The diner can move this pointing device over images projected on the palette; when aligned over a specific image of say a button or icon, that can be interpreted as a selection action. Hence, the image projected onto the palette can include navigation functions as well as selection functions.

To aid detection and tracking of the pointer, the pointer can be equipped with a light source (e.g an infrared LED) that a user can activate using a small switch on the pointer. The LED faces upwards and its position can be readily detected and tracked using an IR camera (typically filtered to pick up only IR). Users can move their pointers over the table top menu items, selecting them by clicking the switch, which in turn activates the IR LED, with the IR camera detecting the IR; the x-y location on the table top of the pointer can then be inferred using software that analyses the location of the light source on each frame of the camera's video output. Multiple pointers can be detected and tracked simultaneously on the same table.

Multi-touch functionality is also possible—for example, users could select an item projected onto the tabletop, and then, by keeping the switch activated, and hence the LED emitting IR, multi-touch functions such as pinch, grab and zoom can be performed.

Benefits would be in the enhanced user experience: games (such as air hockey etc.), drawing, manipulation of backgrounds in pleasing and flowing ways, in essence all the things that you can do on a touch screen device, but on a shared table top, with no technology at the table surface level beyond a disposable LED pointer—therefore low cost. Entertainment along with the interactive ordering of food is hence provided.

Unlike the table in FIG. 11A, which still includes four separate trackpads at each corner (indicated by the four small circles in each corner), the table in FIG. 11B is an entirely conventional table on which are placed the palette and a pointing/selection device.

The dashed line in FIG. 11A and the dashed line in FIG. 11B each indicates a possible division of the diners at the table into two groups.

Relying only on a web cam for interaction allows for increased fluidity in the seating arrangements of people—the palettes can be tracked wherever they are on the table and different palettes associated with different groupings of diners. Furthermore, any surface may be used as an interaction surface.

The dining area belonging to each group of diners can have a unique background colour or image, set by those diners. As the palettes are moved, the boundary between these different areas can automatically change.

### Combined Table and Computer-Controlled Projector Unit, and Interactive Food and/or Drink Ordering System

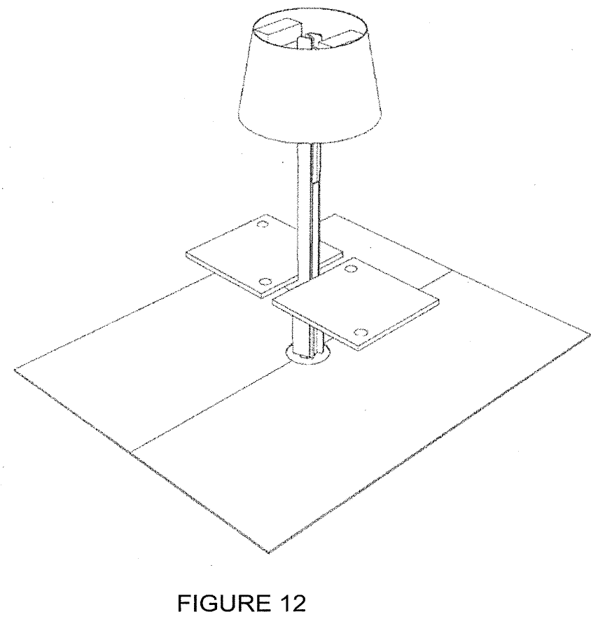

Referring to FIG. 12, there is shown an example of a combined table and computer-controlled projector unit: see concept G. The unit, which may be referred to as the E-Table™, includes a vertical stand, supporting two tables and two projector units at the top of the stand (a single projector can also be used) projecting images onto each table. In an example, the imaging system is the projector; the projector can then be mounted on the stand and positioned above the table, surrounded by a shade. One or more projectors may be mounted on the stand.

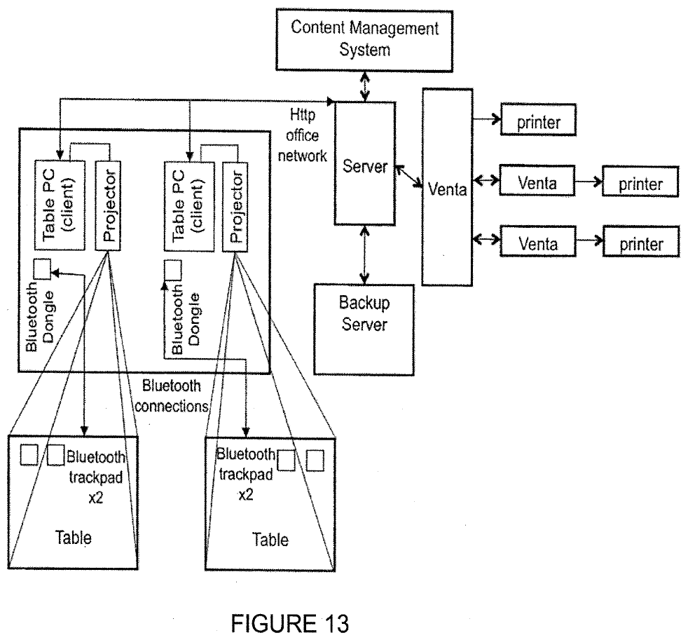

For an interactive food and/or drink ordering system implementation (see FIG. 13 for example), there are four major components: server, networking, tables (as defined for example with reference to FIG. 12) and tills.

### Server

The server component runs the e-table back end server software; the server has a redundant partner and is administered via the CMS [Content Management System] from the office PC.

### Networking

The wireless network router connects the table touch screen to the internal network via Wi-Fi. The sever Office PC and both Venta EPOS tills are physically connected to the internal network. The Venta EPOS printers are physically connected over the internal network using serial over Cat5.

### Tables

The clients (Table PC) are Windows XP embedded running on a Wyse V90L fanless computer. The video output is projected via the Canon LCD projector mounted overhead.

The table touch pads are connected over a secured Bluetooth link, once paired the touch pads feed co-ordinate and click data to the client control panel via COM ports.

### Tills

The tills can run Venta pro EPOS and have backup partners; each till runs a printer that is physically connected using serial over cat5.

The E-table touch screen software is split into three major components: server, client and tills.

### Server

The e-table server acts as a hub for the e-table system, all e-table clients connect via the server. The server then interfaces with Venta EPOS to sell items, print bills; get pricing, product and grouping information and relays this data back to the client.

### Client

The e-table client is the customer facing interface. The E-table interface enables you to do many things including browsing the menu, order items, call for a waiter and calling for your bill.

### Tills

The tills run Venta pro EPOS. Venta EPOS is the product database and holds all product information, it is also responsible handling printing and for telling the server what tables are grouped. Venta EPOS also supplies the office PC with reporting information.

### HALIOS 3d Pointer Notes

(www.elmos.de/englisch/about-us/profil/optoelektronic-halios.html; http://www.mechaless.eu/eng/halios_e.htm)

There is the HALIOS®-principle in the area of optoelectronics. The coinage is the shortcut for High Ambient Light Independent Optical System. This system consists of optical transmission and reception elements (LEDs and photo diodes) as well as an electronic signal-evaluation system.

The system allows movements to be recognized even through closed, infrared-translucent surfaces. Hereby the incident light is evaluated by using two optical transmitters in such a way that only the required information is evaluated by post-connection hard and software. External influences, such as exposure to strong sunlight, have no effect. HALIOS® works without any mechanical parts whatsoever and is therefore wear-free.

HALIOS® allows input complex and free of interferences input devices for the detection up to three-dimensional movement. Because of its high integration HALIOS® needs only very little space.

HALIOS® (High Ambient Light Independent Optical System) fulfils optical sensor requirements. An advantage of this optical measurement principle, which is able to detect any movement by light reflection in all three dimensions, is its immunity to influences by ambient light, even direct sunlight.

Furthermore, the HALIOS® system is self-regulating, compensating any factors of influence like ageing or extreme variations in temperature.

Due to their absolute ambient light immunity, HALIOS® systems opens up application areas for optical sensors and input devices. Despite their extremely small building size, those sensors and input devices are able to recognize movements in all three dimensions.

### Anoto Digital Pen Notes (www.anoto.com)

### Digital Pen

Using a digital pen—Information capture at your fingertips From ink to digital data: quick and easy

A digital pen looks, feels and writes like a normal ballpoint pen. However, it contains an integrated digital camera, an advanced image microprocessor and a mobile communications device for wireless connection.

Using a digital pen you can capture, store and then securely send the handwriting, enabling you to easily convert ink to digital data—right away.

### What Happens When You're Writing

In combination with digital paper, a digital pen starts digitizing handwritten text the moment you put pen to paper. The pen reads and records pen strokes in relation to the digital paper's barely visible pattern of dots.

As you write, the camera built into the pen automatically takes digital snapshots of the dot pattern on the paper at a rate of between 50 and 100 images per second. Every snapshot contains enough data to enable the pen's image microprocessor to determine the exact position of the digital pen and what it writes or draws.

### Pen Data Ready for Transfer

In addition to capturing the coordinates that enable accurate recording of the handwriting, the digital pen appends key data about the handwriting context. This includes the exact time it was written and the identity of the writer—every digital pen has a unique pen ID, which is included every time data is sent from the pen. The pen data also includes details on the specific paper form and page.

All this data is then retained in the pen's memory. The digital pen can store up to 50 full A4/Letter size pages of handwritten data. With the handwritten form or document completed and pen data captured and stored, the user is ready to transfer data from the pen.

### Atracsys Notes

(www.atracsys.com/_products/tracking_systems.php)

Atracsys proposes two families of optical 3D localizers based on active and passive technologies.

accuTrack

Designed to be used close to the tracking site, accuTrack 500 and accuTrack 250 localizers optimize the working volume versus precision equation. accuTrack active system detects the sub-millimetric position of infrared LEDs at a maximum speed of 4000 Hz guaranteeing to capture moving objects without losing any precision.

infiniTrack

infiniTrack is a real-time 3D/6D optical measurement system specially designed to detect and track the pose of objects in real-time video streams. Being simultaneously an active camera as well as a real passive tracking system, infiniTrack can be used in a large number of applications and is compatible with existing image-guided surgery tools already widespread in the medical field.

### Notes

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### Concepts

Multiple concepts A to M are presented in this disclosure. The following may be of assistance in defining these concepts.

### A. An Interactive Food and/or Drink Ordering System with a Shared Menu Zone

An interactive food and/or drink ordering system comprising a computer controlled projector apparatus and a horizontal surface, wherein images from the computer controlled projector apparatus are projected onto some or all of the surface, the images including a menu of food and/or drink selection options, the selection options being selectable by a first user operating an interface device operable to provide input to the computer and also by a second user operating an interface device operable to provide input to the computer, wherein the menu of food and/or drink selection options is projected into a zone on the surface that is shared by the first and second users.
the first user and the second user each operating their own interface device operable to provide input to the computer.
interface devices are connected to the computer.
each interface device is operable to select an option from the zone on the surface that is shared by the first and second users.
the orientation of the menu of food and/or drink selection options projected onto the surface being selected to be correct for each user.
projector apparatus projects a single image that is oriented so that both users can read the menu items the right way up.
zone on the surface is circular.
projector apparatus projects an image that is divided into a menu zone for the first user, and a different menu zone for the second user.
the menu zones have text and images appropriately oriented for each user.
Choices are recorded as those of the first and second users as a group.
First user and second user are seated opposite each other.
the selection options being selectable by a third user operating an interface device operable to provide input to the computer, wherein the menu of food and/or drink selection options is projected into a zone on the surface that is shared by the first, second and third users.
Third user seated opposite neither the first user nor the second user.
Projector apparatus comprises a single projector.
Projector apparatus comprises multiple projectors.
System comprises power and data cables routed through the floor.
System includes an input palette system comprising an input palette, a camera and a tracking computer, wherein a menu of food and/or drink selection options is projected onto the input palette situated on the surface, the selection options being selectable by the first user and also by the second user, the position of the menu of food and/or drink selection options projected onto the surface being selectable by a user according to user positioning of the input palette, wherein the tracking computer is operable to determine the position of the palette through image processing of an image of the palette obtained by the camera, and the computer controlled projector apparatus is operable to change the positioning of the menu in response to the input palette position determined by the tracking computer.
System includes an input pointer system comprising an input pointer, a camera and a tracking computer, wherein a menu of food and/or drink selection options is projected onto the surface, the selection options being selectable by the first user when holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.

A method of ordering food and/or drink in an interactive food and/or drink ordering system, the system comprising a computer controlled projector apparatus and a horizontal surface, wherein images from the computer controlled projector apparatus are projected onto some or all of the surface, the images including a menu of food and/or drink selection options, the selection options being selectable by a first user operating an interface device operable to provide input to the computer and also by a second user operating an interface device operable to provide input to the computer, wherein the menu of food and/or drink selection options is projected into a zone on the surface that is shared by the first and second users, comprising the steps of:

(i) the first user or the second user operating an interface device to select an item of food or drink from the menu projected on the surface, and
(ii) a record of the selection being made in an order record corresponding to the first and second users.

### B. An Interactive Food and/or Drink Ordering System with a Plurality of Shared Menu Zones

An interactive food and/or drink ordering system comprising a computer controlled projector apparatus and a horizontal surface, wherein images from the computer controlled projector apparatus are projected onto a first zone on the surface that is shared by first and second users in a first group of users, the images in the first zone including a menu of food and/or drink selection options, the selection options in the first zone being selectable by the first user operating an interface device operable to provide input to the computer and also by the second user operating an interface device operable to provide input to the computer, and wherein

images from the computer controlled projector apparatus are projected onto a second zone on the surface that is shared by third and fourth users in a second group of users, the images in the second zone including a menu of food and/or drink selection options, the selection options in the second zone being selectable by the third user operating an interface device operable to provide input to the computer and also by the fourth user operating an interface device operable to provide input to the computer.
the first, second, third and fourth users each operating their own interface device operable to provide input to the computer.
interface devices are connected to the computer.
each interface device is operable to select an option from the zone on the surface that is shared by its respective user.
the orientation of the menu of food and/or drink selection options projected onto the surface are selected to be correct for each user.
For each zone, the projector apparatus projects a single image that is oriented so that the respective users can read the menu items the right way up.
Zones on the surface are circular.
For each zone, projector apparatus projects an image that is divided into a respective menu zone for each respective user.
the menu zones have text and images appropriately oriented for each user.
Respective choices are those of the group of users for each respective zone.
First user and second user are seated opposite each other; third user and fourth user are seated opposite each other.
the selection options being selectable by a fifth user operating an interface device operable to provide input to the computer, wherein the menu of food and/or drink selection options is projected into the first zone on the surface that is shared by the first, second and fifth users.
Fifth user seated opposite neither the first user nor the second user.
Zones are adjustable in response to the addition of one or more users to a group of users.
wherein images from the computer controlled projector apparatus are projected onto a third zone on the surface that is shared by two users in a third group of users, the images in the third zone including a menu of food and/or drink selection options, the selection options in the third zone being selectable by the first of the two users in the third group of users operating an interface device operable to provide input to the computer and also by the second of the two users in the third group of users operating an interface device operable to provide input to the computer.
Zones are adjustable in response to the addition of one or more users to a group of users.
Bench seating is provided for some users.
Projector apparatus comprises a single projector.
Projector apparatus comprises multiple projectors.
System comprises power and data cables routed through the floor.
Surface is a table surface, and table division is provided for by movable physical dividers, the system including an image recognition system operable to recognize the table dividers.
Table is circular or rectangular.
System includes an input palette system comprising a first input palette and a second input palette, a camera and a tracking computer, wherein a respective menu of food and/or drink selection options is projected onto a respective input palette situated on the surface, the respective selection options being selectable by a respective user and also by one or more respective additional users, a position of the respective menu of food and/or drink selection options projected onto the surface being selectable by a respective user according to user positioning of a respective input palette, wherein the tracking computer is operable to determine a respective position of a respective input palette through image processing of an image of the respective palette obtained by the camera, and the computer controlled projector apparatus is operable to change the position of the respective menu in response to the respective input palette position determined by the tracking computer.
Input palettes are provided in correspondence with groups of users, and when the palettes corresponding to a group of users are moved, the zone boundary corresponding to the group of users moves accordingly.
System includes an input pointer system comprising an input pointer, a camera and a tracking computer, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.
System wherein each input palette of the input palette system has a corresponding input pointer of the input pointer system.

A method of ordering food and/or drink in an interactive food and/or drink ordering system, the system comprising a computer controlled projector apparatus and a horizontal surface, wherein images from the computer controlled projector apparatus are projected onto a first zone on the surface that is shared by first and second users in a first group of users, the images in the first zone including a menu of food and/or drink selection options, the selection options in the first zone being selectable by the first user operating an interface device operable to provide input to the computer and also by the second user operating an interface device operable to provide input to the computer, and wherein

images from the computer controlled projector apparatus are projected onto a second zone on the surface that is shared by third and fourth users in a second group of users, the images in the second zone including a menu of food and/or drink selection options, the selection options in the second zone being selectable by the third user operating an interface device operable to provide input to the computer and also by the fourth user operating an interface device operable to provide input to the computer, the method comprising the steps of:
(i) the first user, the second user, the third user or the fourth user operating an interface device to select an item of food or drink from the menu projected on the surface in a menu zone corresponding to the user's group,
(ii) a record of the selection being made in an order record corresponding to the user's group.

### C. Input Palette System

Input palette system comprising an input palette, a camera and a tracking computer, the input palette system suitable for use with an interactive food and/or drink ordering system, the ordering system comprising a computer controlled projector apparatus and a horizontal surface, wherein a menu of food and/or drink selection options is projected onto the input palette situated on the surface, the selection options being selectable by a user and also by one or more additional users, the position of the menu of food and/or drink selection options projected onto the surface being selectable by a user according to user positioning of the input palette, wherein the tracking computer is operable to determine the position of the palette through image processing of an image of the palette obtained by the camera, and the computer controlled projector apparatus is operable to change the positioning of the menu in response to the input palette position determined by the tracking computer.
Palette breaks azimuthal symmetry
the orientation of the menu of food and/or drink selection options projected onto the surface is selectable by a user according to user rotation of the input palette, wherein the tracking computer is operable to determine the azimuthal angle of the palette through image processing of an image of the palette obtained by the camera, and the computer controlled projector apparatus is operable to change the orientation of the menu in response to the input palette azimuthal angle determined by the tracking computer.
Input palette is portable
Input palette is a flat disc
disc includes a small hole at one section
palette is a tray
palette is the approximate size of a shared menu zone
palette resembles an oil painter's palette in shape
palette is detected and tracked by a web camera
position of the palette is provided to control the position at which the menu zone is projected
palette includes images or other visual features with sharp, well delineated edges that can be readily recognized using image recognition systems
the palette includes a 2D or 3D barcode
barcode visible only in the IR spectrum
a user can move the palette to any convenient position on the table and the shared menu zone will follow its movement, being continuously projected onto the palette
projector maintains a fixed background image on the table as the palette is moved
palette comprises a handle, and location of the handle is tracked and identified so that the shared menu zone orientation can vary as the palette is rotated
System includes an input pointer system comprising an input pointer, a camera and a tracking computer, the input pointer system suitable for use with the interactive food and/or drink ordering system, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.

Input palette system comprising a first input palette and a second input palette, a camera and a tracking computer, the input palette system suitable for use with an interactive food and/or drink ordering system, the ordering system comprising a computer controlled projector apparatus and a horizontal surface, wherein a respective menu of food and/or drink selection options is projected onto a respective input palette situated on the surface, the respective selection options being selectable by a respective user and also by one or more respective additional users, a position of the respective menu of food and/or drink selection options projected onto the surface being selectable by a respective user according to user positioning of a respective input palette, wherein the tracking computer is operable to determine a respective position of a respective input palette through image processing of an image of the respective palette obtained by the camera, and the computer controlled projector apparatus is operable to change the position of the respective menu in response to the respective input palette position determined by the tracking computer.
Input palette system wherein when the first input palette is stacked on the second input palette, a single shared menu zone is projected onto the first palette.
Input palette system wherein moving the first palette off the stack to a particular section of the surface is immediately tracked by the tracking computer, triggering a new menu zone to be displayed on the second palette by the projector apparatus.
First and second input palettes break azimuthal symmetry
the orientation of the respective menu of food and/or drink selection options projected onto the surface is selectable by a respective user according to user rotation of the respective input palette, wherein the tracking computer is operable to determine an azimuthal angle of the respective palette through image processing of an image of the respective palette obtained by the camera, and the computer controlled projector apparatus is operable to change the orientation of the respective menu in response to the respective input palette azimuthal angle determined by the tracking computer.
System includes an input pointer system comprising an input pointer, a camera and a tracking computer, the input pointer system suitable for use with the interactive food and/or drink ordering system, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.

### D. Input Palette

Input palette, for use with a camera, a tracking computer and an interactive food and/or drink ordering system, the system comprising a computer controlled projector apparatus and a horizontal surface, wherein a menu of food and/or drink selection options is projected onto the input palette situated on the surface, the selection options being selectable by a user and also by one or more additional users, the position of the menu of food and/or drink selection options projected onto the surface being selectable by a user according to user positioning of the input palette, wherein the tracking computer is operable to determine the position of the palette through image processing of an image of the palette obtained by the camera, and the computer controlled projector apparatus is operable to change the positioning of the menu in response to the input palette position determined by the tracking computer.
Palette breaks azimuthal symmetry
Input palette is portable
Input palette is a flat disc
disc includes a small hole at one section
palette is a tray
palette is the approximate size of a shared menu zone
palette resembles an oil painter's palette in shape
palette includes images or other visual features with sharp, well delineated edges that can be readily recognized using image recognition systems
the palette includes a 2D or 3D barcode
barcode visible only in the IR spectrum

### E. Input Pointer System

Input pointer system comprising an input pointer, a camera and a tracking computer, the input pointer system suitable for use with an interactive food and/or drink ordering system, the ordering system comprising a computer controlled projector apparatus and a horizontal surface, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.
Input pointer is a small circular pointer with a short handle
position of the pointer can be detected and tracked using a web-camera
when pointer is aligned over a specific image, that is interpreted as a selection action
specific image is of a button or icon
image projected onto the surface can include navigation functions as well as selection options
pointer is equipped with a light source
light source is an infrared LED
light source is activatable by a user using a switch on the pointer
infrared LED is detected and tracked using an infrared camera
Pointer has multi-touch functionality
multi-touch functionality is one or more of pinch, grab and zoom.
Pointer used in one or more of games, drawing, and background manipulation.
Input pointer comprises a personal, portable touch screen device.
Personal, portable touch screen device is incorporated into a puck-like object, to provide a puck.
Puck acts as a pointing device using either its touch-detecting ability, or an image can be displayed on its screen, or a combination of both functions can be used.
A graphical system displayed on the puck screen provides for controlled input to the interactive food and/or drink ordering system.
Puck has a 2D barcode, which is printed on the puck or displayed on the touch screen display.
Puck has a 2D barcode, which is printed on the puck in infra red ink
2D barcode is unique to a customer.
2D barcode codes for menu items or promotions.
Personal, portable touch screen device includes an accelerometer.

Input pointer system comprising a first input pointer and a second input pointer, a camera and a tracking computer, the input pointer system suitable for use with an interactive food and/or drink ordering system, the ordering system comprising a computer controlled projector apparatus and a horizontal surface, wherein a menu of food and/or drink selection options is projected onto the surface, the selection options being selectable by a respective user holding a respective input pointer, wherein the tracking computer is operable to determine the positions of the first and second input pointers simultaneously through image processing of an image of the surface obtained by the camera, and the computer controlled projector apparatus is operable to provide selection of a respective menu option in response to a respective input pointer position determined by the tracking computer.

### F. Input Pointer

Input pointer suitable for use with a camera, a tracking computer, and an interactive food and/or drink ordering system, the ordering system comprising a computer controlled projector apparatus and a horizontal surface, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.
Input pointer is a small circular pointer with a short handle
pointer is equipped with a light source
light source is an infrared LED
light source is activatable by a user using a switch on the pointer
infrared LED is detected and tracked using an infrared camera
Pointer has multi-touch functionality
multi-touch functionality is one or more of pinch, grab and zoom.
Pointer used in one or more of games, drawing, and background manipulation.

### G. A Combined Table and Computer-Controlled Projector Unit

A combined table and computer-controlled projector unit, comprising:

(a) at least one table;
(b) a stand connected to the table;
(c) a projector controlled by a computer;
(d) an imaging system mounted on the stand, the imaging system causing an image to be projected onto the table.

The combined table and computer-controlled projector unit may be one in which the imaging system is the projector, and the table is supported by the stand.

The combined table and computer-controlled projector unit may be one in which the projector is mounted on the stand and positioned above the table.

The combined table and computer-controlled projector unit may be one in which the imaging system is a mirror oriented to reflect light from the projector onto the table.

The combined table and computer-controlled projector unit may be one in which the projector is mounted on the stand and positioned below the table.

The combined table and computer-controlled projector unit may be one in which the imaging system is surrounded by a shade.

The combined table and computer-controlled projector unit may be one in which the table includes one or more integrated cursor control devices that are connected to the computer.

The combined table and computer-controlled projector unit may be one in which the Cursor control devices are trackpads that are wirelessly connected to the computer

The combined table and computer-controlled projector unit may be one in which the computer is mounted under the table.

The combined table and computer-controlled projector unit may be one in which the computer is connected to a remote server.

The combined table and computer-controlled projector unit may be one in which the computer is connected to an EPOS terminal.

The combined table and computer-controlled projector unit may be one in which the computer is connected wirelessly or by cable to the remote server and EPOS terminal.

The combined table and computer-controlled projector unit may be one in which the unit forms part of an interactive food and/or drink ordering system.

The combined table and computer-controlled projector unit may be one in which the computer controlled projector projects a menu of food and/or drink selection options onto some or all of the table surface.

The combined table and computer-controlled projector unit may be one in which the selection options are selectable by a user operating an interface device connected to the computer, such as a wireless track pad.

The combined table and computer-controlled projector unit may be one in which is portable, in that the unit can be moved to different positions in a room or other space and does not have to be permanently installed.

The combined table and computer-controlled projector unit may be one which needs only a power source and data connectivity to operate.

The combined table and computer-controlled projector unit may be one in which the data connectivity is wireless.

The combined table and computer-controlled projector unit may be one in which the data connectivity is cable-based.

The combined table and computer-controlled projector unit may be one in which the stand includes one or more rigid members to support the table and the imaging system.

The combined table and computer-controlled projector unit may be one in which the stand is a single vertical rigid member mounted on a floor panel.

The combined table and computer-controlled projector unit may be one in which the stand includes at least one rigid member to support a table and a different rigid member to support the imaging system.

The combined table and computer-controlled projector unit may be one being modular in that multiple such units can be pushed together to form a larger, combined unit, with flush fitting sides.

The combined table and computer-controlled projector unit may be one in which power cabling is routed through the floor.

Premises including a combined table and computer-controlled projector unit defined under concept G.

### H. Management System

A management system, comprising a hub, a set of clients, and a point of sale system, the management system operable to be controlled by management tool software wherein the management tool software provides a user interface.

The management system may be a table management system including tables.

The management system may be such that the management tool software is running on a computer terminal connected to the hub.

The management system may be such that the management tool software is running on the hub.

The table management system may be such that each table is operable to run a client from the set of clients.

The table management system may be such that the management tool software is operable to select a particular client from the set of clients to run on a particular table.

The management system may be such that the hub comprises an ordering process.

The management system may be such that the hub comprises a web service.

The management system may be such that the hub comprises an EPOS Abstraction.

The management system may be such that the hub comprises an ordering process, wherein the ordering process is associated with a client.

The management system may be such that the hub comprises a web service, wherein the web service is associated with a client.

The management system may be such that the hub comprises an EPOS Abstraction, wherein the EPOS Abstraction is associated with a client.

The management system may be such that the point of sale system is selectable from a set of point of sale systems using the management tool software.

The table management system may be such that the hub is an E-Table hub.

The management system may be such that the hub is connected to an EPOS.

The management system may be such that the hub is operable to provide one or more of: an interactive food and/or drink ordering interface, a computer game, a computer software application, a movie, a playstation running game, or a Nintendo Wii playing game.

The management system may be such that the hub is operable to provide one or more of a plurality of client-facing software applications.

The table management system may be such that the management tool software is operable to change a client facing interface at a table.

The management system may be such that the management tool software is operable to change a client facing interface in real time.

The management system may be such that the management tool software requires a username and password, so that only designated staff can operate the management tool software.

The management system may be operable to receive input from a plurality of input technologies.

The management system may be operable to receive input from a games remote control.

The table management system may be such that a receiver associated with a given table may be operable to receive input from a plurality of input technologies.

The table management system may be such that a receiver associated with a given table may be operable to receive input from a games remote control.

Use of the management system in a stadium, a hotel room, a conference centre, an airport, a nightclub, a train, an aeroplane, or an e-learning centre.

The table management system may be such that a given table provides an interactive food and/or drink ordering system comprising a computer controlled projector apparatus and a horizontal surface, wherein images from the computer controlled projector apparatus are projected onto some or all of the surface, the images including a menu of food and/or drink selection options, the selection options being selectable by a user operating an interface device operable to provide input to the computer.

The table management system may be such that a given table provides an interactive food and/or drink ordering system comprising a computer controlled projector apparatus and a horizontal surface, wherein images from the computer controlled projector apparatus are projected onto some or all of the surface, the images including a menu of food and/or drink selection options, the selection options being selectable by a first user operating an interface device operable to provide input to the computer and also by a second user operating an interface device operable to provide input to the computer, wherein the menu of food and/or drink selection options is projected into a zone on the surface that is shared by the first and second users.

The table management system may be such that a given table provides an interactive food and/or drink ordering system comprising a computer controlled projector apparatus and a horizontal surface, wherein images from the computer controlled projector apparatus are projected onto a first zone on the surface that is shared by first and second users in a first group of users, the images in the first zone including a menu of food and/or drink selection options, the selection options in the first zone being selectable by the first user operating an interface device operable to provide input to the computer and also by the second user operating an interface device operable to provide input to the computer, and wherein

images from the computer controlled projector apparatus are projected onto a second zone on the surface that is shared by third and fourth users in a second group of users, the images in the second zone including a menu of food and/or drink selection options, the selection options in the second zone being selectable by the third user operating an interface device operable to provide input to the computer and also by the fourth user operating an interface device operable to provide input to the computer.

The table management system may be such that a given table provides an input palette system comprising an input palette, a camera and a tracking computer, the input palette system suitable for use with an interactive food and/or drink ordering system, the ordering system comprising a computer controlled projector apparatus and a horizontal surface, wherein a menu of food and/or drink selection options is projected onto the input palette situated on the surface, the selection options being selectable by a user and also by one or more additional users, the position of the menu of food and/or drink selection options projected onto the surface being selectable by a user according to user positioning of the input palette, wherein the tracking computer is operable to determine the position of the palette through image processing of an image of the palette obtained by the camera, and the computer controlled projector apparatus is operable to change the positioning of the menu in response to the input palette position determined by the tracking computer.

The table management system may be such that a given table includes an input palette, for use with a camera, a tracking computer and an interactive food and/or drink ordering system, the system comprising a computer controlled projector apparatus and a horizontal surface, wherein a menu of food and/or drink selection options is projected onto the input palette situated on the surface, the selection options being selectable by a user and also by one or more additional users, the position of the menu of food and/or drink selection options projected onto the surface being selectable by a user according to user positioning of the input palette, wherein the tracking computer is operable to determine the position of the palette through image processing of an image of the palette obtained by the camera, and the computer controlled projector apparatus is operable to change the positioning of the menu in response to the input palette position determined by the tracking computer.

The table management system may be such that a given table provides an input pointer system comprising an input pointer, a camera and a tracking computer, the input pointer system suitable for use with an interactive food and/or drink ordering system, the ordering system comprising a computer controlled projector apparatus and a horizontal surface, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.

The table management system may be such that a given table includes an input pointer suitable for use with a camera, a tracking computer, and an interactive food and/or drink ordering system, the ordering system comprising a computer controlled projector apparatus and a horizontal surface, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.

The table management system may be such that a given table provides a combined table and computer-controlled projector unit, comprising:

(a) at least one table;
(b) a stand connected to the table;
(c) a projector controlled by a computer;
(d) an imaging system mounted on the stand, the imaging system causing an image to be projected onto the table.

### I. Table Grouping and Parameter Selection System

A table grouping and parameter selection system comprising tables and a table management system, the table management system comprising a hub and a point of sale system, the table management system operable to be controlled by management tool software wherein the management tool software provides a user interface, the management tool software operable via the user interface to select groups of tables, and to apply a set of selectable parameters to each group of tables.

The table grouping and parameter selection system may be such that the management tool software is running on a computer terminal connected to the hub.

The table grouping and parameter selection system may be such that the management tool software is running on the hub.

The table grouping and parameter selection system may be such that the selectable parameters include a table theme parameter.

The table grouping and parameter selection system may be such that the selectable parameters include table menu parameters, or a table menu parameter.

The table grouping and parameter selection system may be such that the table menu parameters include a food menu parameter and a drinks menu parameter.

The table grouping and parameter selection system may be such that the selectable parameters include a pattern image parameter.

The table grouping and parameter selection system may be such that the management tool software is operable to move a selected table into a predefined group of tables.

The table grouping and parameter selection system may be such that the management tool software is operable to enter a reservation comprising a group of tables and a date and time corresponding to the reservation.

The table grouping and parameter selection system may be such that a given table provides an interactive food and/or drink ordering system comprising a computer controlled projector apparatus and a horizontal surface, wherein images from the computer controlled projector apparatus are projected onto some or all of the surface, the images including a menu of food and/or drink selection options, the selection options being selectable by a first user operating an interface device operable to provide input to the computer and also by a second user operating an interface device operable to provide input to the computer, wherein the menu of food and/or drink selection options is projected into a zone on the surface that is shared by the first and second users.

The table grouping and parameter selection system may be such that a given table provides an interactive food and/or drink ordering system comprising a computer controlled projector apparatus and a horizontal surface, wherein images from the computer controlled projector apparatus are projected onto a first zone on the surface that is shared by first and second users in a first group of users, the images in the first zone including a menu of food and/or drink selection options, the selection options in the first zone being selectable by the first user operating an interface device operable to provide input to the computer and also by the second user operating an interface device operable to provide input to the computer, and wherein

images from the computer controlled projector apparatus are projected onto a second zone on the surface that is shared by third and fourth users in a second group of users, the images in the second zone including a menu of food and/or drink selection options, the selection options in the second zone being selectable by the third user operating an interface device operable to provide input to the computer and also by the fourth user operating an interface device operable to provide input to the computer.

The table grouping and parameter selection system may be such that a given table provides an input palette system comprising an input palette, a camera and a tracking computer, the input palette system suitable for use with an interactive food and/or drink ordering system, the ordering system comprising a computer controlled projector apparatus and a horizontal surface, wherein a menu of food and/or drink selection options is projected onto the input palette situated on the surface, the selection options being selectable by a user and also by one or more additional users, the position of the menu of food and/or drink selection options projected onto the surface being selectable by a user according to user positioning of the input palette, wherein the tracking computer is operable to determine the position of the palette through image processing of an image of the palette obtained by the camera, and the computer controlled projector apparatus is operable to change the positioning of the menu in response to the input palette position determined by the tracking computer.

The table grouping and parameter selection system may be such that a given table includes an input palette, for use with a camera, a tracking computer and an interactive food and/or drink ordering system, the system comprising a computer controlled projector apparatus and a horizontal surface, wherein a menu of food and/or drink selection options is projected onto the input palette situated on the surface, the selection options being selectable by a user and also by one or more additional users, the position of the menu of food and/or drink selection options projected onto the surface being selectable by a user according to user positioning of the input palette, wherein the tracking computer is operable to determine the position of the palette through image processing of an image of the palette obtained by the camera, and the computer controlled projector apparatus is operable to change the positioning of the menu in response to the input palette position determined by the tracking computer.

The table grouping and parameter selection system may be such that a given table provides an input pointer system comprising an input pointer, a camera and a tracking computer, the input pointer system suitable for use with an interactive food and/or drink ordering system, the ordering system comprising a computer controlled projector apparatus and a horizontal surface, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.

The table grouping and parameter selection system may be such that a given table includes an input pointer suitable for use with a camera, a tracking computer, and an interactive food and/or drink ordering system, the ordering system comprising a computer controlled projector apparatus and a horizontal surface, wherein a menu of food and/or drink selection options is projected onto the surface, the selection options being selectable by a user holding the input pointer, wherein the tracking computer is operable to determine the position of the pointer through image processing of an image of the surface obtained by the camera, and the computer controlled projector apparatus is operable to provide selection of a menu option in response to the input pointer position determined by the tracking computer.

The table grouping and parameter selection system may be such that a given table provides a combined table and computer-controlled projector unit, comprising:

(a) at least one table;
(b) a stand connected to the table;
(c) a projector controlled by a computer;
(d) an imaging system mounted on the stand, the imaging system causing an image to be projected onto the table.

### J. Multi-Establishment Management System

A multi-establishment management system comprising a super-hub operable to be controlled by super-hub management tool software, the super-hub connected to a plurality of sub-management systems, each sub-management system comprising a hub, a set of clients, and a point of sale system, each sub-management system operable to be controlled by respective management tool software.

The multi-establishment management system may be a multi-establishment table management system, wherein the sub-management systems are table management systems, each table management system comprising tables.

The multi-establishment management system wherein the super-hub management tool software provides a user interface.

The multi-establishment management system may be such that the super-hub management tool software is running on a computer terminal connected to the super-hub.

The multi-establishment management system may be such that the super-hub management tool software is running on the super-hub.

The multi-establishment management system may be such that the super-hub management tool software requires a username and password, so that only designated staff can operate the super-hub management tool software.

### K. System of Multi-Establishment Management System and Connected Sub-Management Systems

A system comprising:

(i) a multi-establishment management system comprising a super-hub operable to be controlled by super-hub management tool software, and
(ii) a plurality of sub-management systems, each sub-management system comprising a hub, a set of clients, and a point of sale system, each sub-management system operable to be controlled by respective management tool software,
wherein the super-hub is connected to the plurality of sub-management systems.

The system may be one in which the multi-establishment management system is a multi-establishment table management system, wherein the sub-management systems are table management systems, each table management system comprising tables.

The system may be one in which the super-hub is connected to the plurality of sub-management systems via a respective hub in each sub-management system.

The system may be one in which the multi-establishment management system super-hub management tool software provides a user interface.

The system may be such that the super-hub management tool software is running on a computer terminal connected to the super-hub.

The system may be such that the super-hub management tool software is running on the super-hub.

The system may be such that for each table management system, each table is operable to run a client from the respective set of clients.

The system may be such that for each table management system, the respective management tool software is operable to select a particular client from the set of clients to run on a particular table.

The system may be such that for each sub-management system, the hub comprises an ordering process.

The system may be such that for each sub-management system, the hub comprises a web service.

The system may be such that for each sub-management system, the hub comprises an EPOS Abstraction.

The system may be such that for each sub-management system, the hub comprises an ordering process, wherein the ordering process is associated with a client.

The system may be such that for each sub-management system, the hub comprises a web service, wherein the web service is associated with a client.

The system may be such that for each sub-management system, the hub comprises an EPOS Abstraction, wherein the EPOS Abstraction is associated with a client.

The system may be such that for each sub-management system, the point of sale system is selectable from a set of point of sale systems using the management tool software.

The system may be such that for each table management system, the hub is an E-Table hub.

The system may be such that for each sub-management system, the hub is connected to an EPOS.

The system may be such that for each table management system, the hub is operable to provide at a table one or more of: an interactive food and/or drink ordering interface, a computer game, a computer software application, a movie, a playstation running game, or a Nintendo Wii playing game.

The system may be such that for each table management system, the hub is operable to provide at a table one or more of a plurality of client-facing software applications.

The system may be such that for each table management system, the management tool software is operable to change a client facing interface at a table.

The system may be such that for each table management system, the management tool software is operable to change a client facing interface at a table in real time.

The system may be such that for each sub-management system, the management tool software requires a username and password, so that only designated staff can operate the management tool software.

The system may be such that each sub-management system is operable to receive input from a plurality of input technologies.

The system may be such that each sub-management system is operable to receive input from a games remote control.

The system may be such that each table management system is such that a receiver associated with a given table may be operable to receive input from a plurality of input technologies.

The system may be such that each table management system is such that a receiver associated with a given table may be operable to receive input from a games remote control.

### L. Guest Action Recognition System

Guest Action Recognition System comprising a restaurant computer system and an object, wherein when a group of diners arrive at a restaurant they receive the object that is linked to their group within the restaurant's computer system, where the object is operable to be recognised anywhere within the restaurant as an identifier of that group and their orders which are placed in response to the provision of a menu by the restaurant computer system.

### M. Table Drawing Tool System

Table drawing tool system comprising a table, a restaurant computer system, and an optical output system operable to illuminate the table under the control of the restaurant computer system, wherein the table drawing tool is an application that allows customers at tables to create their own tablecloth images.

1. A management system, comprising a hub, wireless clients each including a respective touch screen, and management tool software embodied on a non-transitory storage medium; the management system operable to be controlled by the management tool software executable on the hub, wherein the management tool software provides a user interface, the hub providing a web service, wherein the wireless clients are configured to provide an ordering process using the web service, in connection with the hub, and wherein the hub is configured to provide an interactive food and/or drink ordering interface on a respective touch screen of a respective wireless client, using the web service.

2. The management system of claim 1, wherein a wireless client is configured to order from the ordering interface, and to pay, using the web service.

3. The management system of claim 1, wherein the ordering interface displays allergy information about the food.

4. The management system of claim 1, wherein the management system includes customer tracking.

5. The management system of claim 4, wherein the management system includes a camera, the management system configured to provide the customer tracking including face recognition using the camera.

6. The management system of claim 4, wherein the management system includes a camera and 2D barcodes, the management system configured to provide the customer tracking including performing customer tracking using the 2D barcodes, using the camera.

7. The management system of claim 6, wherein a 2D barcode is unique to a customer.

8. The management system of claim 6, wherein a 2D barcode is a QR code.

9. The management system of claim 6, wherein the 2D barcode uniquely identifies a location.

10. The management system of claim 1, wherein the management system includes a robot, wherein the robot is configured to bring ordered food to a customer.

11. The management system of claim 1, wherein the wireless clients are portable.

12. The management system of claim 1, wherein the wireless clients include a mobile phone.

13. The management system of claim 1, wherein the wireless clients include a smartphone.

14. The management system of claim 1, wherein customers order using their own wireless device.

15. The management system of claim 1, wherein the management system includes a point of sale system.

16. The management system of claim 15, wherein the point of sale system provides reporting information.

17. The management system of claim 1, wherein the management tool software is operable to change a client facing interface in real time.

18. The management system of claim 1, wherein the management system is a restaurant management system.

19. A method of delivering food and/or drink to a home address, the method including the steps of:
(i) using a management system, comprising a hub, a wireless client including a touch screen, and management tool software embodied on a non-transitory storage medium, the management system operable to be controlled by the management tool software executable on the hub, wherein the management tool software provides a user interface, and wherein the hub provides a web service;
(ii) the wireless client providing an ordering process using the web service, in connection with the hub;
(iii) the hub providing an interactive food and/or drink ordering interface on the touch screen of the wireless client, using the web service;
(iv) the management system receiving a food and/or drink order including an address, from the wireless client, using the web service, for delivery to the address, and
(v) delivering the ordered food and/or drink to the address.

20. The method of claim 19, the method including the step of receiving a payment from the wireless client, using the web service.

21. A method of providing food and/or drink to take away, the method including the steps of:
(i) using a management system, comprising a hub, a wireless client including a touch screen, and management tool software embodied on a non-transitory storage medium, the management system operable to be controlled by the management tool software executable on the hub, wherein the management tool software provides a user interface, and wherein the hub provides a web service;
(ii) the wireless client providing an ordering process using the web service, in connection with the hub;
(iii) the hub providing an interactive food and/or drink ordering interface on the touch screen of the wireless client, using the web service;
(iv) the management system receiving a food and/or drink order from the wireless client, using the web service, and
(v) providing the ordered food and/or drink to take away.

22. The method of claim 21, the method including the step of receiving a payment from the wireless client, using the web service.
